(19) United States
(12) Patent Application Publication
(10) Pub. No.: US 2025/0209565 A1
(43) Pub. Date: Jun. 26, 2025

(54) Method For Dynamic Summary and Detailed Views For Spatial Transcriptomics

(71) Applicant: ILLUMINA, INC., San Diego, CA (US)

(72) Inventors: Benjamin Luke Moore, Cambridge (GB); Christopher Edlund, Carisbad, CA (US)

(21) Appl. No.: 18/983,749

(22) Filed: Dec. 17, 2024

Related U.S. Application Data
(60) Provisional application No. 63/614,493, filed on Dec. 22, 2023.

(51) Int. Cl. G06T 3/40

(52) U.S. Cl. CPC G06T 3/40; G06T 2200/24

(57) ABSTRACT

Systems and methods for dynamic summary and detailed views for spatial transcriptomics are described. In a first implementation, a method includes: presenting a first display representing a region of tissue at a first zoom level. The region of tissue is divided into first bins each having a first resolution. The first display indicates first feature values related to spatial transcriptomics. Each of the first feature values are selected from a set of candidate feature values. In response to receiving a selection to zoom in on a portion of the region at a second zoom level, presenting a second display representing the portion at the second zoom level. The portion is divided into second bins each having a second resolution which correspond to smaller areas than the first bins. The second display indicates second feature values, where the second feature values are selected from the same set of candidate feature values.

### CROSS-REFERENCE TO RELATED APPLICATIONS

This application claims priority to U.S. Provisional Patent Application No. 63/614,493, filed Dec. 22, 2023, entitled “Method for Dynamic Summary and Detailed Views for Spatial Transcriptomics,” the entire disclosure of which is hereby expressly incorporated by reference herein.

### FIELD OF THE INVENTION

The present disclosure generally relates to the field of spatial transcriptomics and, in particular, to displaying dynamic summary and detailed views of spatial transcriptomics data on a graphical user interface (GUI).

### BACKGROUND

Spatial transcriptomics is an emerging field where assays generate large volumes of granular gene expression data across a section of tissue retaining spatial information. This data can be viewed within a GUI. However, due to the significant volume of granular gene expression data there may be several challenges in storing and rendering the data. For example, data shown at a high level may obscure important data which can only be seen at a more granular level. Additionally, to present data at a very granular level, the system may need to store millions or even billions of data points which can be very memory intensive and time consuming to render graphics at such a high level of granularity.

### SUMMARY

To address these issues, a spatial transcriptomics display system may present spatial transcriptomics data for a region of tissue at multiple resolutions: a summary view and a detailed view. In this manner, users may be able to view the spatial transcriptomics data at varying levels of detail without constantly rendering and/or re-rendering image data.

More specifically, in the summary view, the region of tissue is divided into a first set of bins having a first resolution (e.g., a resolution of 100 μm). Each bin is overlayed with an indicator of a first feature value for the bin for a feature related to spatial transcriptomics (e.g., a number of reads within the bin, a cluster assigned to the bin based on gene expression patterns, a genome annotation for the bin, etc.). The user may view the entire region of tissue in the viewport for the summary view or may zoom in on a portion of the region of tissue. However, as the user changes the zoom level within the summary view, the scale of the viewport may change but the resolution of the bins presented within the viewport stays the same.

The summary view may include a range of zoom levels below a threshold zoom level. For example, the user may be able to zoom in on the summary view from zoom levels 1 to 5, where the resolution of the bins remains at the first resolution (e.g., a resolution of 100 μm). Then when the zoom level is higher than the threshold zoom level, the spatial transcriptomics display system may present a detailed view in the viewport of a portion of the region of tissue. In the detailed view, the portion of the region of tissue is divided into a second set of bins having a second resolution (e.g., a resolution of 10 μm) which is smaller than the first resolution. Each of the second bins is overlayed with an indicator of a second feature value for the second bin for a feature related to spatial transcriptomics (e.g., a number of reads within the bin, a cluster assigned to the bin, a genome annotation for the bin, etc.).

In some implementations, feature values are selected such that they are consistent across multiple bin resolutions. For example, for a particular feature (e.g., a cluster), a set of candidate feature values is selected such that the same set of candidate feature values are used to assign feature values to the first and second bins. More specifically, the spatial transcriptomics display system may identify the set of candidate feature values based on the spatial transcriptomics data within the higher resolution bins (e.g., the second bins). For example, the spatial transcriptomics display system may cluster the second bins into 10 clusters based on their gene expression patterns. Then the spatial transcriptomics display system may select from the same 10 clusters to assign cluster values as first feature values for the first bins.

One way to keep the feature values consistent across multiple bins resolutions is to use a plurality vote system. The spatial transcriptomics display system may identify a subset of the second bins which cover the same area as a first bin. The spatial transcriptomics display system may then obtain the respective second feature values for these second bins. Then the spatial transcriptomics display system may identify the second feature value which occurs most frequently in the subset as the first feature value for the first bin. For example, if the subset includes 10 bins and 6 of them are assigned to cluster 1, then the first bin will be assigned to cluster 1 since the majority of the subset is assigned to cluster 1.

Another way to keep the feature values consistent across multiple bin resolutions is to generate a polygon across a contiguous portion of the higher resolution bins (e.g., the second bins) having the same feature value. Then the spatial transcriptomics display system may maintain the shape of the polygon in the summary view. More specifically, the spatial transcriptomics display system may overlay several polygons in the summary view, where each polygon indicates a feature value (e.g., a green polygon indicates cluster 1, a blue polygon indicates cluster 2, etc.).

In accordance with a first implementation, a method for presenting spatial transcriptomics data at a plurality of resolutions is disclosed. The method may comprise: presenting, by one or more processors in a viewport, a first display representing a region of tissue at a first zoom level. The region of tissue is divided into first bins each having a first resolution. The first display indicates first feature values for the first bins within the region of tissue for a feature related to spatial transcriptomics, where each of the first feature values is selected from a set of candidate feature values. In response to receiving a selection of a user control to zoom in on a portion of the region at a second zoom level, the method includes presenting, by the one or more processors in the viewport, a second display representing the portion of the region at the second zoom level. The portion of the region is divided into second bins each having a second resolution which correspond to smaller areas within the region of tissue than the first bins. The second display indicates second feature values for the second bins within the portion of the region, where the second feature values are selected from the same set of candidate feature values, such that the first and second feature values are consistent across the first and second resolutions.

In accordance with the first implementation, the method may further comprise: identifying, by the one or more processors, the set of candidate feature values using spatial transcriptomics data within each of the second bins; assigning, by the one or more processors, the first feature values from the set of candidate feature values to the first bins; and/or assigning, by the one or more processors, the second feature values from the set of candidate feature values to the second bins.

In accordance with the first implementation, assigning a first feature value to one of the first bins may include: identifying, by the one or more processors, a subset of the second bins which are located within an area corresponding to the first bin; identifying, by the one or more processors, second feature values for the subset of the second bins; and/or identifying, by the one or more processors, a second feature value which occurs most frequently in the subset as the first feature value.

In accordance with the first implementation, the method may further comprise: dividing, by the one or more processors, the region of tissue into a plurality of tiles; and/or for each tile, storing, by the one or more processors, the second feature values for a subset of the second bins which are located within an area corresponding to the tile in memory. Additionally or alternatively, the method may also comprise: in response to receiving a selection of a user control to zoom in at a particular location: identifying, by the one or more processors, the tile which corresponds to the particular location; retrieving, by the one or more processors, the second feature values for the subset of the second bins which correspond to the tile from the memory; and/or presenting, by the one or more processors, the tile in the viewport, including the retrieved second feature values for the subset of second bins which correspond to the tile.

In accordance with the first implementation, presenting the first display may include: generating, by the one or more processors, a polygon outlining a contiguous portion of the second bins each having a same second feature value, wherein the polygon includes an indicator representing the second feature value; and/or presenting, by the one or more processors, the polygon in the first display overlaying one or more first bins corresponding to the contiguous portion of the second bins, such that the polygon indicates one or more first feature values for the one or more first bins.

In accordance with the first implementation, the first bins at the first resolution may be displayed for a first range of zoom levels lower than a threshold zoom level, and the second bins at the second resolution may be displayed for a second range of zoom levels higher than the threshold zoom level.

In accordance with the first implementation, the second display may be presented in the viewport in response to receiving a selection of a user control to view the portion of the region at a zoom level which is higher than the threshold zoom level.

In accordance with the first implementation, the method may further comprise: in response to receiving a selection of a user control to view the portion of the region at a zoom level which is lower than the threshold zoom level, presenting, by the one or more processors, the portion of the region in the viewport with the first bins at the first resolution.

In accordance with the first implementation, the method may further comprise: filtering, by the one or more processors, the viewport to present a subset of the candidate feature values.

In accordance with the first implementation, the feature related to spatial transcriptomics may be a group of clusters within the region of tissue according to at least gene expression, such that each of the candidate feature values corresponds to one of the group of clusters.

In accordance with a second implementation, a system for presenting spatial transcriptomics data at a plurality of resolutions is disclosed. The system may comprise one or more processors, one or more memories coupled to the one or more processors, and/or computer-readable instructions stored in the one or more memories. The computer-readable instructions, when executed by the one or more processors, may cause the system to: present, in a viewport, a first display representing a region of tissue at a first zoom level. The region of tissue is divided into first bins each having a first resolution. The first display indicates first feature values for the first bins within the region of tissue for a feature related to spatial transcriptomics, where each of the first feature values selected from a set of candidate feature values. In response to receiving a selection of a user control to zoom in on a portion of the region at a second zoom level, the instructions cause the system to present, in the viewport, a second display representing the portion of the region at the second zoom level. The portion of the region is divided into second bins each having a second resolution which correspond to smaller areas within the region of tissue than the first bins. The second display indicates second feature values for the second bins within the portion of the region, where the second feature values are selected from the same set of candidate feature values, such that the first and second feature values are consistent across the first and second resolutions.

In accordance with the second implementation, the computer-readable instructions, when executed by the one or more processors, may further cause the system to: identify the set of candidate feature values using spatial transcriptomics data within each of the second bins, assign the first feature values from the set of candidate feature values to the first bins, and/or assign the second feature values from the set of candidate feature values to the second bins.

In accordance with the second implementation, to assign a first feature value to one of the first bins, the instructions cause the system to: identify a subset of the second bins which are located within an area corresponding to the first bin, identify second feature values for the subset of the second bins, and/or identify a second feature value which occurs most frequently in the subset as the first feature value.

In accordance with the second implementation, the computer-readable instructions, when executed by the one or more processors, may further cause the system to: divide the region of tissue into a plurality of tiles, for each tile, store the second feature values for a subset of the second bins which are located within an area corresponding to the tile in memory, and/or in response to receiving a selection of a user control to zoom in at a particular location: identify the tile which corresponds to the particular location, retrieve the second feature values for the subset of the second bins which correspond to the tile from the memory, and/or present the tile in the viewport, including the retrieved second feature values for the subset of second bins which correspond to the tile.

In accordance with the second implementation, to present the first display, the instructions cause the system to: generate a polygon outlining a contiguous portion of the second bins each having a same second feature value, wherein the polygon includes an indicator representing the second feature value, and/or present the polygon in the first display overlaying one or more first bins corresponding to the contiguous portion of the second bins, such that the polygon indicates one or more first feature values for the one or more first bins.

In accordance with the second implementation, the first bins at the first resolution may be displayed for a first range of zoom levels lower than a threshold zoom level, and the second bins at the second resolution may be displayed for a second range of zoom levels higher than the threshold zoom level.

In accordance with the second implementation, the second display may be presented in the viewport in response to receiving a selection of a user control to view the portion of the region at a zoom level which is higher than the threshold zoom level.

In accordance with the second implementation, the computer-readable instructions, when executed by the one or more processors, may further cause the system to: in response to receiving a selection of a user control to view the portion of the region at a zoom level which is lower than the threshold zoom level, present the portion of the region in the viewport with the first bins at the first resolution.

In accordance with the second implementation, the computer-readable instructions, when executed by the one or more processors, may further cause the system to: filter the viewport to present a subset of the candidate feature values.

In accordance with the second implementation, the feature related to spatial transcriptomics may be a group of clusters within the region of tissue according to at least gene expression, such that each of the candidate feature values corresponds to one of the group of clusters.

In accordance with a third implementation, a non-transitory computer-readable medium storing instructions for presenting spatial transcriptomics data at a plurality of resolutions is disclosed. The instructions, when executed by one or more processors, may cause the one or more processors to: present, in a viewport, a first display representing a region of tissue at a first zoom level. The region of tissue is divided into first bins each having a first resolution. The first display indicates first feature values for the first bins within the region of tissue for a feature related to spatial transcriptomics, where each of the first feature values selected from a set of candidate feature values. In response to receiving a selection of a user control to zoom in on a portion of the region at a second zoom level, the instructions cause the one or more processors to present, in the viewport, a second display representing the portion of the region at the second zoom level. The portion of the region is divided into second bins each having a second resolution which correspond to smaller areas within the region of tissue than the first bins. The second display indicates second feature values for the second bins within the portion of the region, where the second feature values are selected from the same set of candidate feature values, such that the first and second feature values are consistent across the first and second resolutions.

In accordance with the third implementation, the instructions, when executed by the one or more processors, may further cause the one or more processors to: identify the set of candidate feature values using spatial transcriptomics data within each of the second bins, assign the first feature values from the set of candidate feature values to the first bins, and/or assign the second feature values from the set of candidate feature values to the second bins.

In accordance with the third implementation, to assign a first feature value to one of the first bins, the instructions cause the one or more processors to: identify a subset of the second bins which are located within an area corresponding to the first bin, identify second feature values for the subset of the second bins, and/or identify a second feature value which occurs most frequently in the subset as the first feature value.

In accordance with the third implementation, the instructions, when executed by the one or more processors, may further cause the one or more processors to: divide the region of tissue into a plurality of tiles, for each tile, store the second feature values for a subset of the second bins which are located within an area corresponding to the tile in memory, and/or in response to receiving a selection of a user control to zoom in at a particular location: identify the tile which corresponds to the particular location, retrieve the second feature values for the subset of the second bins which correspond to the tile from the memory, and/or present the tile in the viewport, including the retrieved second feature values for the subset of second bins which correspond to the tile.

In accordance with the third implementation, to present the first display, the instructions cause the one or more processors to: generate a polygon outlining a contiguous portion of the second bins each having a same second feature value, wherein the polygon includes an indicator representing the second feature value, and/or present the polygon in the first display overlaying one or more first bins corresponding to the contiguous portion of the second bins, such that the polygon indicates one or more first feature values for the one or more first bins.

In accordance with the third implementation, the first bins at the first resolution may be displayed for a first range of zoom levels lower than a threshold zoom level, and the second bins at the second resolution may be displayed for a second range of zoom levels higher than the threshold zoom level.

In accordance with the third implementation, the second display may be presented in the viewport in response to receiving a selection of a user control to view the portion of the region at a zoom level which is higher than the threshold zoom level.

In accordance with the third implementation, the instructions, when executed by the one or more processors, may further cause the one or more processors to: in response to receiving a selection of a user control to view the portion of the region at a zoom level which is lower than the threshold zoom level, present the portion of the region in the viewport with the first bins at the first resolution.

In accordance with the third implementation, the instructions, when executed by the one or more processors, may further cause the one or more processors to: filter the viewport to present a subset of the candidate feature values.

In accordance with the third implementation, the feature related to spatial transcriptomics may be a group of clusters within the region of tissue according to at least gene expression, such that each of the candidate feature values corresponds to one of the group of clusters.

Advantages will become more apparent to those of ordinary skill in the art from the following description of the preferred implementations which have been shown and described by way of illustration. As will be realized, the present implementations may be capable of other and different implementations, and their details are capable of modification in various respects. Accordingly, the drawings and description are to be regarded as illustrative in nature and not as restrictive.

### BRIEF DESCRIPTION OF THE DRAWINGS

The Figures described below depict various implementations of the system and methods disclosed therein. It should be understood that each Figure depicts a particular implementation of the disclosed system and methods, and that each of the Figures is intended to accord with a possible implementation thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present implementations are not limited to the precise arrangements and instrumentalities shown, wherein:

FIG. 1 is a block diagram of an example computing device for presenting the summary and detailed views of spatial transcriptomics data for a region of tissue in accordance with the teachings of this disclosure.

FIG. 2 illustrates a flow diagram of an example method for presenting spatial transcriptomics data at a plurality of resolutions, which can be implemented in a computing device, such as the computing device of FIG. 1.

FIG. 3A illustrates an example graphical user interface presenting a zoomed-out summary view of spatial transcriptomics data for a region of tissue (e.g., a mouse brain) in accordance with the teachings of this disclosure.

FIG. 3B illustrates an example graphical user interface presenting a zoomed-in summary view of the spatial transcriptomics data for the region of tissue in accordance with the teachings of this disclosure.

FIG. 3C illustrates an example graphical user interface presenting a further zoomed-in summary view of the spatial transcriptomics data for the region of tissue in accordance with the teachings of this disclosure.

FIG. 3D illustrates an example graphical user interface presenting yet another zoomed-in summary view of the spatial transcriptomics data for the region of tissue in accordance with the teachings of this disclosure.

FIG. 3E illustrates an example graphical user interface presenting a zoomed-out detailed view of the spatial transcriptomics data for the region of tissue in accordance with the teachings of this disclosure.

FIG. 3F illustrates an example graphical user interface presenting a zoomed-in detailed view of the spatial transcriptomics data for the region of tissue in accordance with the teachings of this disclosure.

FIG. 3G illustrates an example graphical user interface presenting a further zoomed-in detailed view of the spatial transcriptomics data for the region of tissue in accordance with the teachings of this disclosure.

FIG. 3H illustrates an example graphical user interface presenting an even further zoomed-in detailed view of the spatial transcriptomics data for the region of tissue in accordance with the teachings of this disclosure.

FIG. 4A illustrates another example graphical user interface presenting a zoomed-out summary view of spatial transcriptomics data for a region of tissue with a user control for selecting to filter the features presented in the summary view for a particular gene or set of genes in accordance with the teachings of this disclosure.

FIG. 4B illustrates an example graphical user interface presenting the summary view of FIG. 4A filtered for a selected gene in accordance with the teachings of this disclosure.

FIG. 4C illustrates an example graphical user interface presenting a zoomed-in version of the filtered summary view in accordance with the teachings of this disclosure.

FIG. 4D illustrates an example graphical user interface presenting yet another zoomed-in version of the filtered summary view in accordance with the teachings of this disclosure.

FIG. 4E illustrates an example graphical user interface presenting a detailed view of the spatial transcriptomics data for the region of tissue filtered for the selected gene in accordance with the teachings of this disclosure.

FIG. 5A illustrates an example graphical user interface presenting a zoomed-out summary view for a region of tissue divided into low resolution bins assigned clusters according to gene expression in accordance with the teachings of this disclosure.

FIG. 5B illustrates another an example graphical user interface presenting a zoomed-out summary view for a region of tissue divided into low resolution bins assigned clusters according to gene expression in accordance with the teachings of this disclosure.

FIG. 5C illustrates an example graphical user interface presenting a zoomed-in summary view for a region of tissue divided into low resolution bins assigned clusters according to gene expression in accordance with the teachings of this disclosure.

FIG. 5D illustrates an example graphical user interface presenting a further zoomed-in summary view for a region of tissue divided into low resolution bins assigned clusters according to gene expression in accordance with the teachings of this disclosure.

FIG. 5E illustrates an example graphical user interface presenting a zoomed-out detailed view for a region of tissue divided into high resolution bins assigned clusters according to gene expression which are selected from the same set of clusters as the low resolution bins in accordance with the teachings of this disclosure.

FIG. 5F illustrates another example graphical user interface presenting a zoomed-in detailed view for a region of tissue divided into high resolution bins assigned clusters according to gene expression in accordance with the teachings of this disclosure.

FIG. 6A illustrates an example graphical user interface presenting a user control for selecting to filter the features presented in the summary for a particular cluster or set of clusters in accordance with the teachings of this disclosure.

FIG. 6B illustrates an example graphical user interface presenting a zoomed-out summary view for a region of tissue overlaid with low resolution bins assigned the particular cluster selected in FIG. 6A in accordance with the teachings of this disclosure.

FIG. 6C illustrates another example graphical user interface presenting a zoomed-out summary view for a region of tissue overlaid with low resolution bins assigned the particular cluster in accordance with the teachings of this disclosure.

FIG. 6D illustrates an example graphical user interface presenting a zoomed-in summary view for a region of tissue overlaid with low resolution bins assigned the particular cluster in accordance with the teachings of this disclosure in accordance with the teachings of this disclosure.

FIG. 6E illustrates another example graphical user interface presenting a zoomed-out detailed view for a region of tissue divided into high resolution bins assigned the particular cluster in accordance with the teachings of this disclosure.

FIG. 7A illustrates an example graphical user interface presenting a user control for selecting the transparency level to use when overlaying bins on the region of tissue in accordance with the teachings of this disclosure.

FIG. 7B illustrates another example graphical user interface presenting a summary view for a region of tissue using the transparency level selected in FIG. 7A in accordance with the teachings of this disclosure.

The Figures depict preferred implementations for purposes of illustration only. Alternative implementations of the systems and methods illustrated herein may be employed without departing from the principles of the invention described herein.

### DETAILED DESCRIPTION

Although the following text discloses a detailed description of implementations of methods, apparatuses and/or articles of manufacture, it should be understood that the legal scope of the property right is defined by the words of the claims set forth at the end of this document. Accordingly, the following detailed description is to be construed as examples only and does not describe every possible implementation, as describing every possible implementation would be impractical, if not impossible. Numerous alternative implementations could be implemented, using either current technology or technology developed after the filing date of this patent. It is envisioned that such alternative implementations would still fall within the scope of the claims.

### Exemplary Computing Device

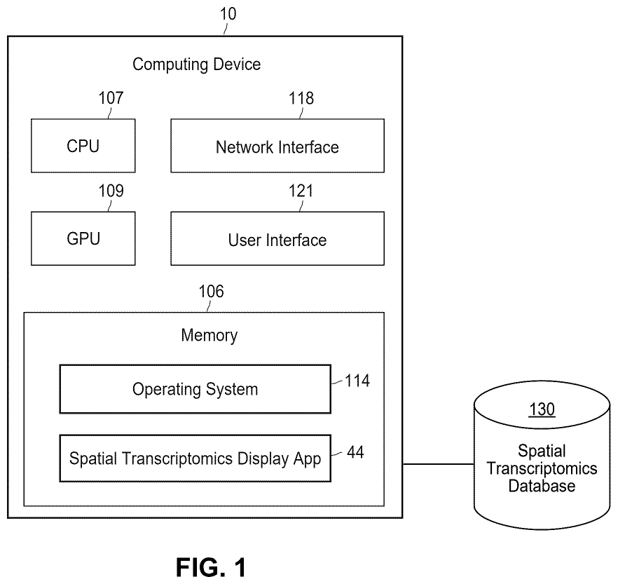

FIG. 1 illustrates a block diagram of an example computing device 10 which may be used to present spatial transcriptomics data for a region of tissue at multiple resolutions. The computing device 10 may be a desktop computer, a laptop computer, a smart phone, a tablet computer, a server, a personal digital assistant (PDA), a wearable device such as a smart watch or smart glasses, a virtual reality headset, etc.

The computing device 10 includes a memory 106, one or more processors 107, a graphics processing unit (GPU) 109, a network interface 118, and a user interface (UI) 121. The memory 106 can be a non-transitory memory and can include one or several suitable memory modules, such as random access memory (RAM), read-only memory (ROM), flash memory, other types of persistent memory, etc. The UI 121 may include a touch screen, a display, a keyboard, one or more speakers, a mouse, a track ball, and/or a voice recognition system. The touch screen and/or the display may display a graphical user interface GUI.

The memory 106 stores an operating system (OS) 114, which can be any type of suitable mobile or general-purpose operating system. The memory 106 also stores the spatial transcriptomics display application 44 which is configured to display a region of tissue, such as a section of a mouse brain. The spatial transcriptomics display application 44 obtains spatial transcriptomics data for locations within the region of tissue, for example from a spatial transcriptomics database 130. More specifically, the spatial transcriptomics data may include reads of genomic sequences and their corresponding locations within the region of tissue, genes expressed at corresponding locations within the regions of tissue, cell types at corresponding locations within the region of tissue, etc. The spatial transcriptomics display application 44 may divide the region of tissue into two sets of bins having different resolutions: low resolution bins for a summary view and high resolution bins for a detailed display view, where the high resolution bins correspond to smaller areas than the low resolution bins. For example, the low resolution bins may be 100 μm×100 μm square subregions of the region of tissue, while the high resolution bins may be 10 μm×10 μm square subregions of the region of tissue. In other implementations, the transcriptomics display application 44 may divide the region of tissue into more than two sets of bins having different resolutions. For example, the region of tissue may be divided into first set of bins having a first resolution (e.g., 100 μm×100 μm), a second set of bins having a second resolution (e.g., 10 μm×10 μm), a third set of bins having a third resolution (e.g., 1 μm×1 μm), a fourth set of bins having a fourth resolution (e.g., 100 nm×100 nm), etc. In any event, the transcriptomics display application 44 may divide the region of tissue into any suitable number of sets of bins having any suitable number of different resolutions.

The spatial transcriptomics display application 44 may assign features values to each bin for features related to spatial transcriptomics. For example, one feature may be a count of the number of reads at locations within the area covered by each bin. Another feature may be a cluster assigned to each bin based on the genes expressed at locations within the area covered by the bin. Related genes may be assigned the same cluster. Yet another feature may be a genome annotation for the genes expressed at locations within the area covered by each bin. The genome annotation may be a structural or a functional annotation.

In some implementations, the spatial transcriptomics display application 44 assigns feature values for the features such that they are consistent across multiple bin resolutions. For example, for a particular feature (e.g., a cluster), the spatial transcriptomics display application 44 selects a set of candidate feature values such that the same set of candidate feature values are used to assign feature values to the high resolution and low resolution bins. More specifically, the spatial transcriptomics display application 44 may identify the set of candidate feature values based on the spatial transcriptomics data for the high resolution bins. For example, the spatial transcriptomics display application 44 may cluster the high resolution bins into one of 10 clusters based on the genes expressed at locations within the area covered by each high resolution bin. Then the spatial transcriptomics display application 44 may select from the same 10 clusters to assign clusters to the low resolution bins.

In any event, the spatial transcriptomics display application 44 presents a summary view of the region of tissue using the low resolution bins and indications of feature values at each low resolution bin (e.g., read count, cluster, etc.) via the GUI 121. For example, the indications may be a heat map such that bins with higher read counts are assigned warmer colors (e.g., orange, red) while bins with lower read counts are assigned cooler colors (e.g., yellow, blue). In another example, the indications may be colors where each color represents a different cluster (e.g., cluster 1 is red, cluster 2 is orange, cluster 3 is green, etc.).

A user may zoom in on a portion of region of tissue at various zoom levels, and the spatial transcriptomics display application 44 may present a zoomed-in version of the summary view using larger and larger versions of the low resolution bins. Then when the user zooms in past a threshold zoom level, the spatial transcriptomics display application 44 presents a detailed view of the region of tissue using the high resolution bins and indications of feature values at each high resolution bin (e.g., read count, cluster, etc.) via the GUI 121.

In some implementations, the computing device 10 stores the image of the region of tissue 401 as a raster image. The computing device 10 also stores the low resolution bins and corresponding feature values for the various features so that the viewport 450 can be rendered quickly when the user views an initial zoomed-out summary view.

The computing device 10 also divides the region of tissue into tiles and/or divides the high resolution bins into tiles. For example, 1,000 high resolution bins corresponding to the bottom right corner of the region of tissue may correspond to one tile, while 1,000 high resolution bins corresponding to the upper right corner of the region of tissue may correspond to another tile.

Then the computing device 10 stores each tile of high resolution bins and corresponding feature values for various features in the memory, for example as pre-generated raster images. In this manner, when a user zooms in on a particular location within the region of tissue, the spatial transcriptomics display application 44 identifies the tile corresponding to the particular location. Then the spatial transcriptomics display application 44 retrieves the high resolution bins and corresponding feature values from the memory. For example, the spatial transcriptomics display application 44 may retrieve a pre-generated raster image for the tile from the memory, and present the tile in the viewport. In this manner, the high resolution bins can be presented quickly and efficiently, without having to generate the feature values for the high resolution bins and/or the image as it is requested. This reduces the loading time for displaying the high resolution bins when the user zooms in past the threshold zoom level.

It is noted that although FIG. 1 illustrates the spatial transcriptomics display application 44 as a standalone application, the functionality of the spatial transcriptomics display application 44 also can be provided in the form of an online service accessible via a web browser executing on the computing device 10, as a plug-in or extension for another software application executing on the computing device 10, etc. The spatial transcriptomics display application 44 generally can be provided in different versions for different respective operating systems. For example, the maker of the computing device 10 can provide a Software Development Kit (SDK) including the spatial transcriptomics display application 44 for the Android™ platform, another SDK for the iOS™ platform, etc.

Additionally, the computing device 10 may communicate with other devices through a network via the network interface 118. The network may be a public network, such as the Internet, or a private network such as an intranet. For example, the computing device 10 may obtain at least some of the spatial transcriptomics data, the detailed view, or the summary view from a remote server.

### Exemplary Method

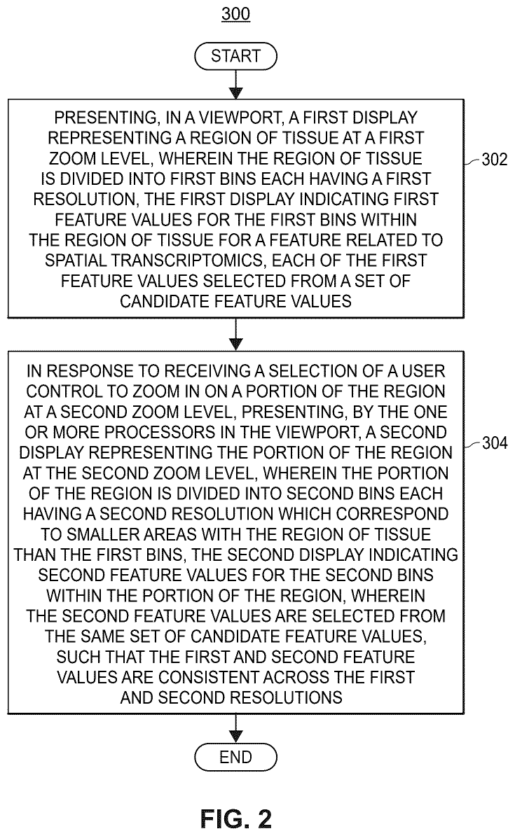

FIG. 2 illustrates a flow diagram of an example method 300 for presenting spatial transcriptomics data at a plurality of resolutions. The method can be implemented in a set of instructions stored on a computer-readable memory and executable at one or more processors of the computing device 10. For example, the method can be implemented by the spatial transcriptomics display application 44.

The method 300 may begin by presenting, by one or more processors (e.g., the one or more processors 107) in a viewport, a first display representing a region of tissue at a first zoom level (block 302). The region of tissue is divided into first bins each having a first resolution (e.g., 100 μm low resolution bins). The first display indicates first feature values for the first bins within the region of tissue for a feature related to spatial transcriptomics. Each of the first feature values is selected from a set of candidate feature values (e.g., clusters 1-10). For example, the first display may be the summary view as described herein.

The first zoom level may be a default zoom level and/or a minimum zoom level (e.g., zoom level 0), such that the entire region of tissue is presented within the viewport. The user may be able to adjust the zoom level to any zoom level between a minimum and maximum zoom level, such as by rotating the wheel of a computer mouse, touching a touch screen, interacting with a GUI zoom element, etc. As the user zooms in, smaller portions of the region of tissue are presented within the viewport at larger scales.

The first bins may be low resolution bins corresponding to subregions of the region of tissue. For example, if the first resolution is 100 μm, the first bins may represent 100 μm×100 μm square areas within the region of tissue or 10,000 μm². In another example, if the first resolution is 100 μm, the first bins may represent 50 μm radial wide circular areas within the region of tissue or about 7854 μm².

In some implementations, the feature related to spatial transcriptomics may be a group of clusters within the region of tissue according to gene expression. Respective candidate feature values within the set of candidate feature values correspond to one of the group of clusters. As an example, a first cluster (Cluster 1) may correspond to a first set of gene expression patterns, a second cluster (Cluster 2) may correspond to a second set of gene expression patterns, a third cluster (Cluster 3) may correspond to a third set of gene expression patterns, and so on. In this example, the group of clusters would be the set of candidate feature values. The first feature values are the clusters within the group of clusters assigned to each bin within the first bins.

In response to receiving a selection of a user control to zoom in on a portion of the region at a second zoom level, the method 300 may continue by presenting, by the one or more processors in the viewport, a second display representing the portion of the region at the second zoom level (block 304). The portion of the region is divided into second bins each having a second resolution (e.g., 10 μm high resolution bins) which correspond to smaller areas within the region of tissue than the first bins. The second display indicates second feature values for the second bins within the portion of the region, where the second feature values are selected from the same set of candidate feature values, such that the first and second feature values are consistent across the first and second resolutions. The second display may be the detailed view as described herein.

The second zoom level may be higher than the first zoom level. In some implementations, the summary view is presented for a first range of zoom levels (e.g., zoom levels 0 to 5). Then when the user zooms in past a threshold zoom level (e.g., zoom level 5), the detailed view is presented with high resolution bins.

The second bins may be high resolution bins corresponding to subregions of the region of tissue. For example, if the second resolution is 10 μm, the second bins may represent 10 μm×10 μm square areas within the region of tissue or 100 μm². In another example, if the second resolution is 10 μm, the second bins may represent 5 μm radial wide circular areas within the region of tissue or about 79 μm².

Referring to the example illustrated above regarding groups of clusters, the second feature values are the clusters assigned to each bin within the second bins. In some implementations, the candidate feature values are determined using the spatial transcriptomics data for the second bins. For example, a group of clusters may be identified based on the gene expression patterns within the second bins. Then for the first bins, clusters are assigned to the first bins using the same group of clusters identified for the second bins.

For example, the clusters for the first bins may be assigned using a majority vote system. For each first bin having a low resolution, a subset of the second bins having high resolution may be identified which cover the same area as the first bin. For example, if a low resolution bin covers a 10,000 μm² area in the upper left corner of the region of tissue, 100 high resolution bins that each cover a 100 μm² area within the upper left corner of region of tissue may be identified. The respective feature values for these high resolution bins may be obtained. Then the feature value which occurs most frequently in the subset is used as the feature value for the low resolution bin. For example, if the subset includes 100 high resolution bins and 60 of them are assigned to cluster 1, then the low resolution bin will be assigned to cluster 1 since the majority of the subset is assigned to cluster 1.

In additional and/or alternative implementations, the one or more processors may generate a polygon in the first display that follows the perimeter along neighboring squares in the second display that share the same second candidate feature value. For example, four neighboring 100 μm² square subregions may share the same second candidate feature value. These four neighboring 100 μm² square subregions are arranged in a Z-tetromino shape, the one or more processors may outline the Z-tetromino shape and present this shape (and/or the second candidate feature value) at the same location within the first display. The shape may be filled in with a particular color to indicate the feature value. For example, a green polygon may correspond to cluster 1, a red polygon may correspond to cluster 2, etc.

The method 300 may have more or less or different steps and/or may be performed in a different sequence. For example, as mentioned above, the transcriptomics display application 44 may divide the region of tissue into more than two sets of bins having different resolutions. In this manner, the detailed view may be presented when the user zooms in past a first threshold zoom level (e.g., zoom level 5) with second bins having a higher resolution than the first bins. Then when the user zooms in past a second threshold zoom level (e.g., zoom level 10), a further detailed view may be presented with third bins (e.g., 1 μm×1 μm) having a higher resolution than the second bins and corresponding to smaller areas within the region of tissue than the second bins. When the user zooms in past a third threshold zoom level (e.g., zoom level 15), an even further detailed view may be presented with fourth bins (e.g., 100 nm×100 nm) having a higher resolution than the third bins and corresponding to smaller areas within the region of tissue than the third bins, etc.

The further detailed view indicates third feature values for the third bins within the portion of the region, where the third feature values are selected from the same set of candidate feature values, such that the first, second, and third feature values are consistent across the first, second, and third resolutions. The even further detailed view may indicate fourth feature values for the fourth bins within the portion of the region, where the fourth feature values are selected from the same set of candidate feature values, such that the first, second, third, and fourth feature values are consistent across the first, second, third, and fourth resolutions, etc.

### Exemplary Graphical User Interfaces

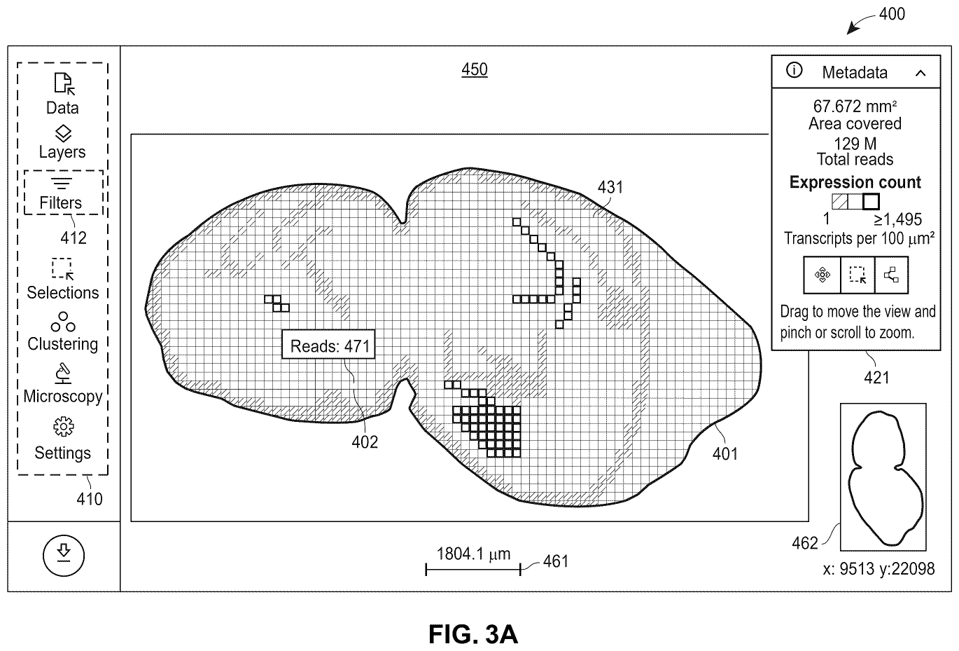

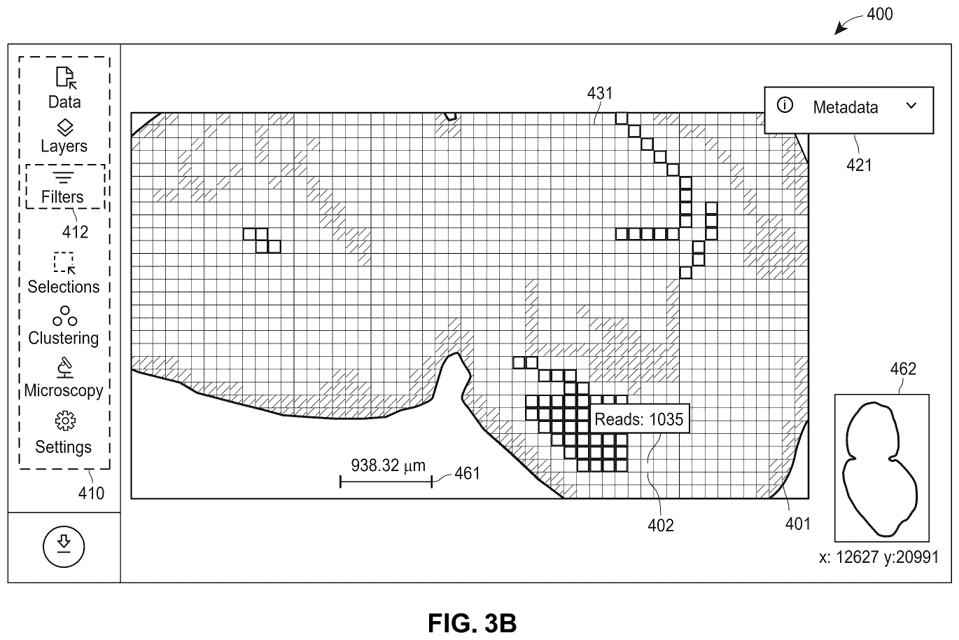

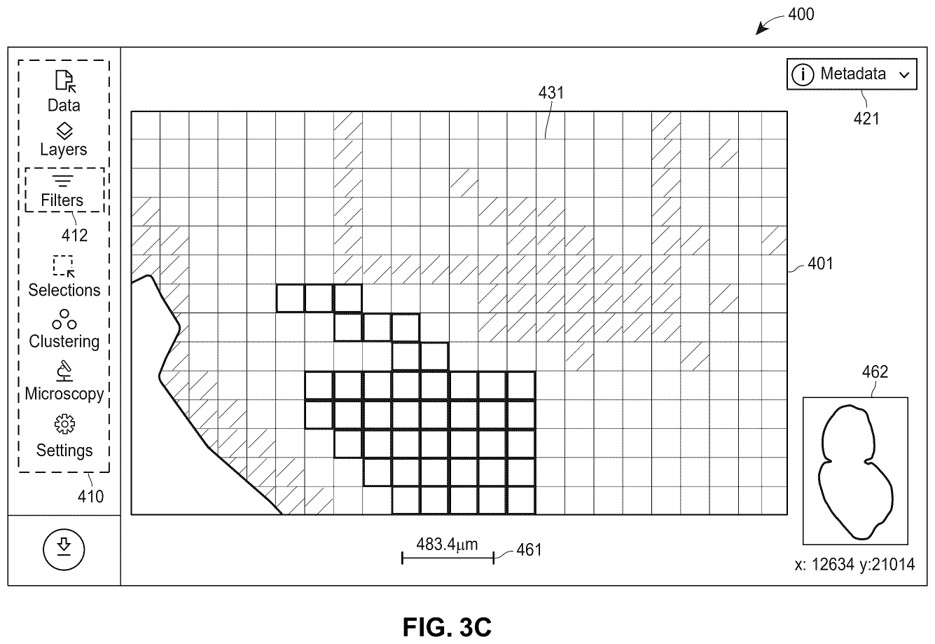

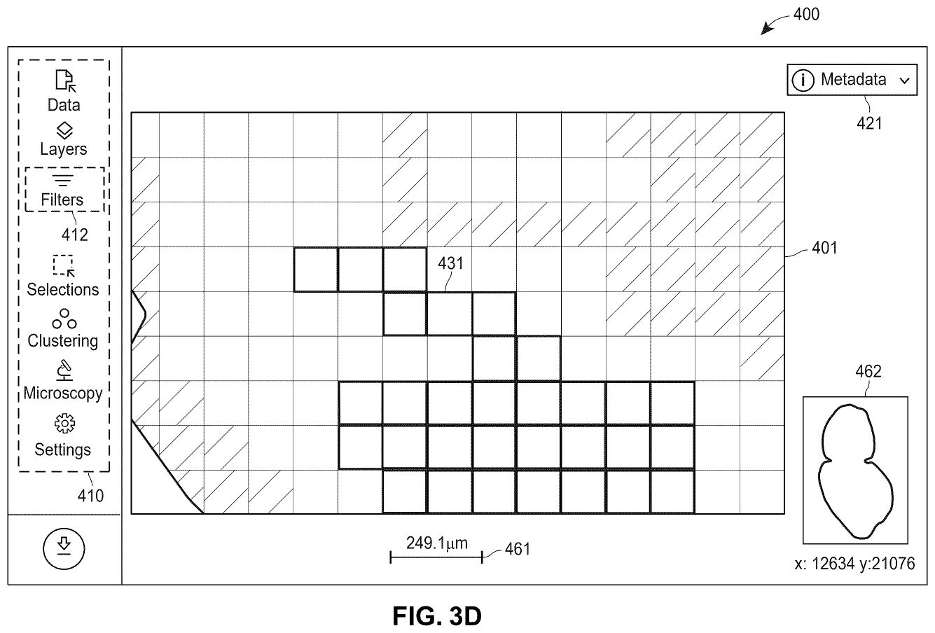

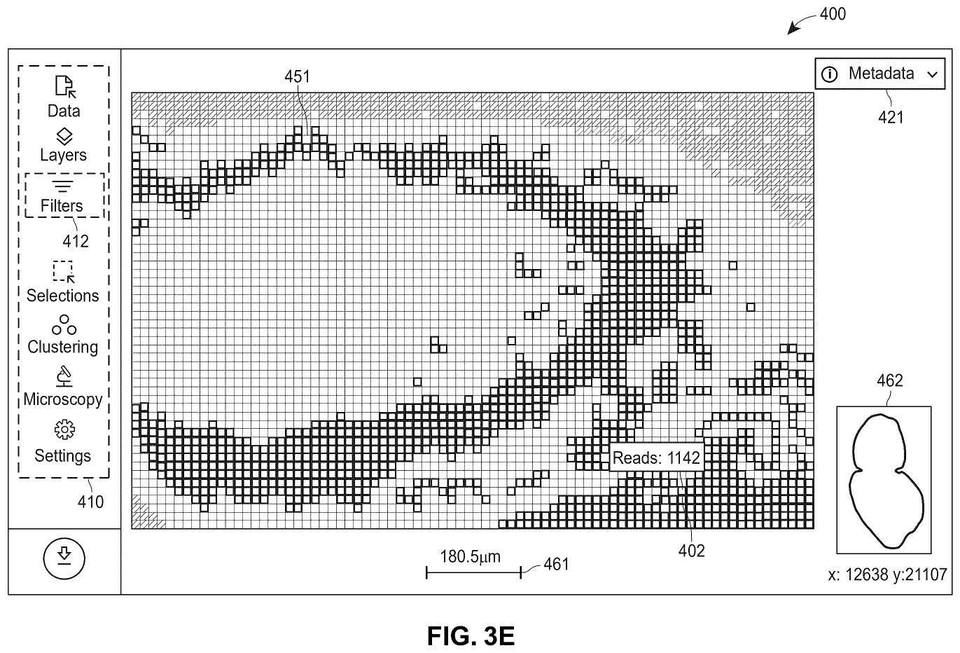

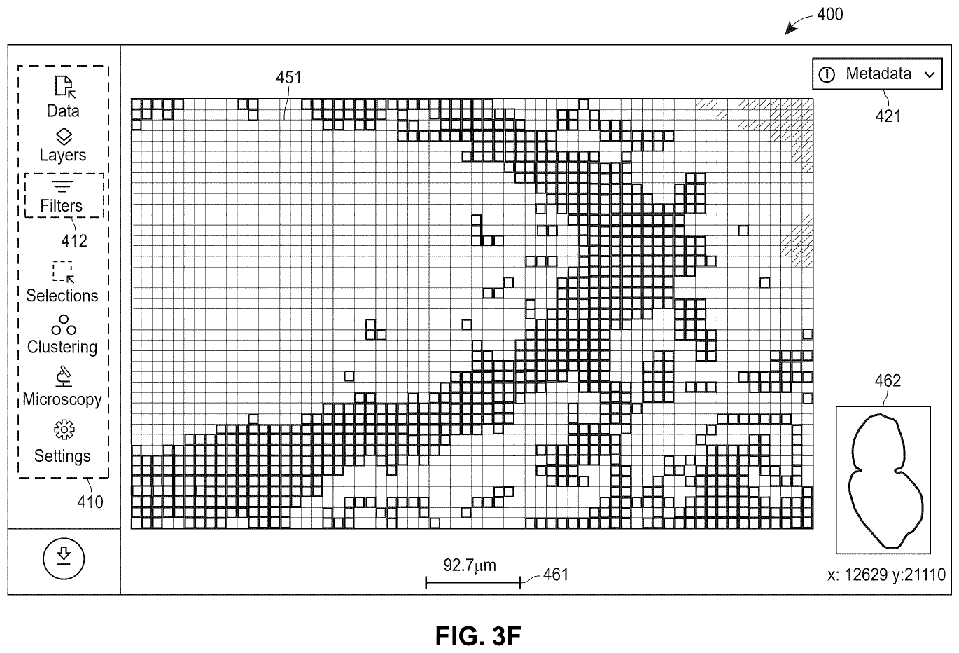

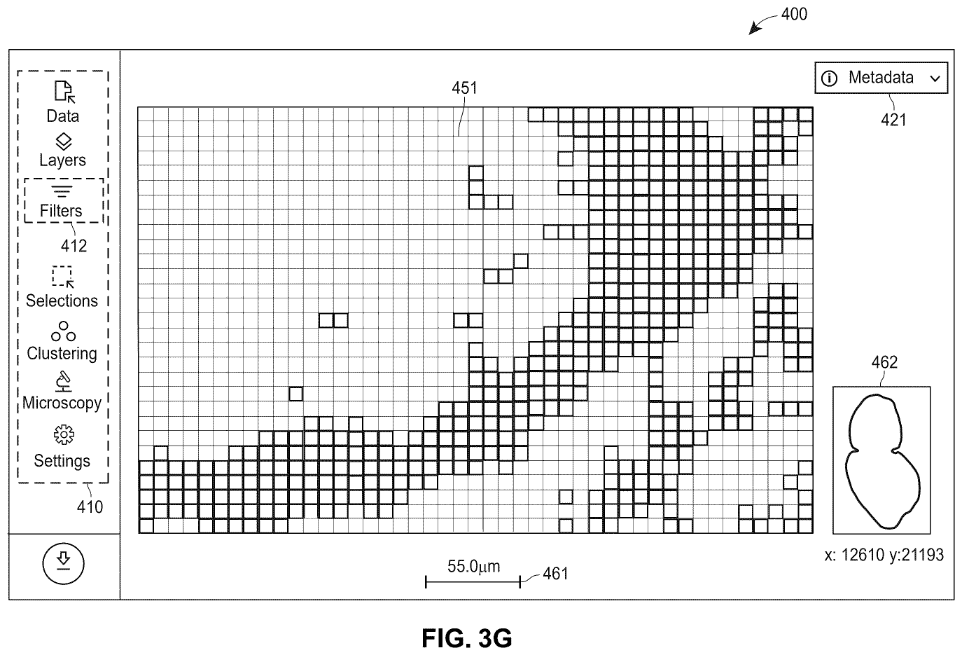

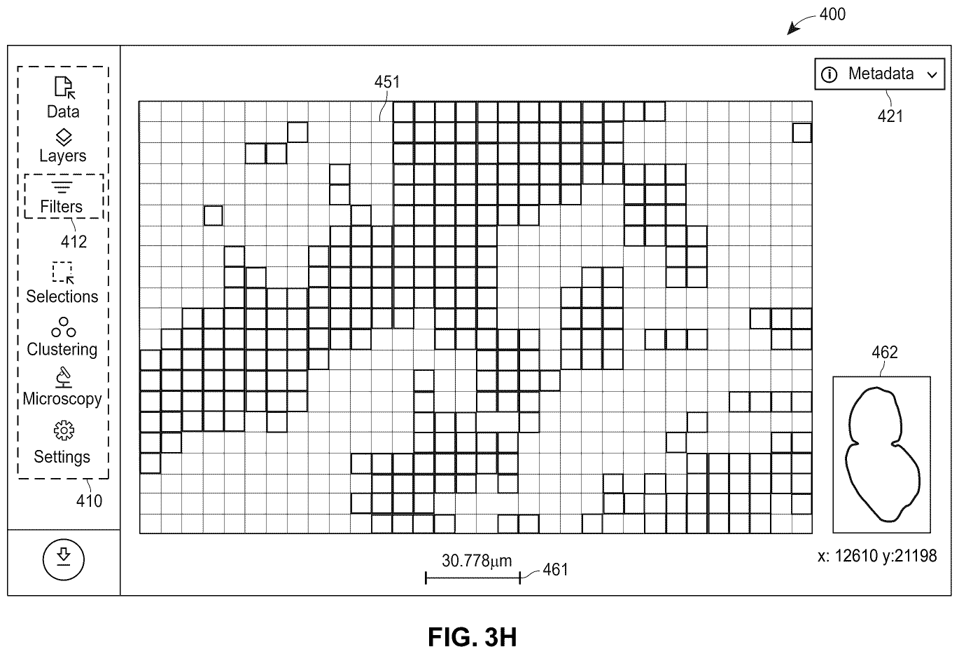

FIGS. 3A-7B depict example graphical user interfaces (GUIs) that may be displayed within a viewport on a UI 121 of a computing device 10. For example, the GUIs may be presented by the spatial transcriptomics display application 44.

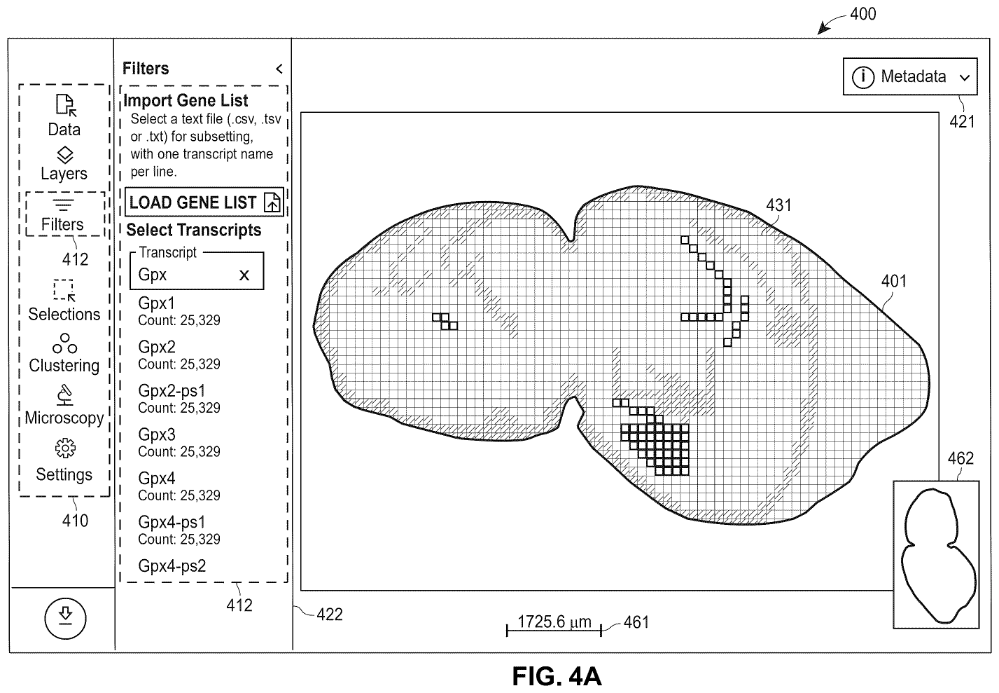

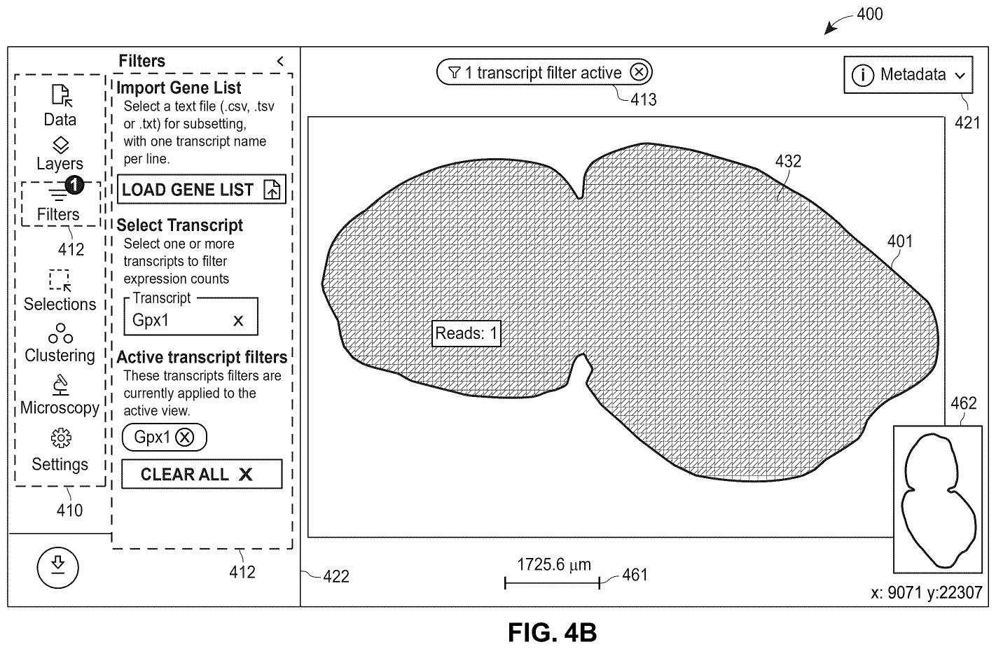

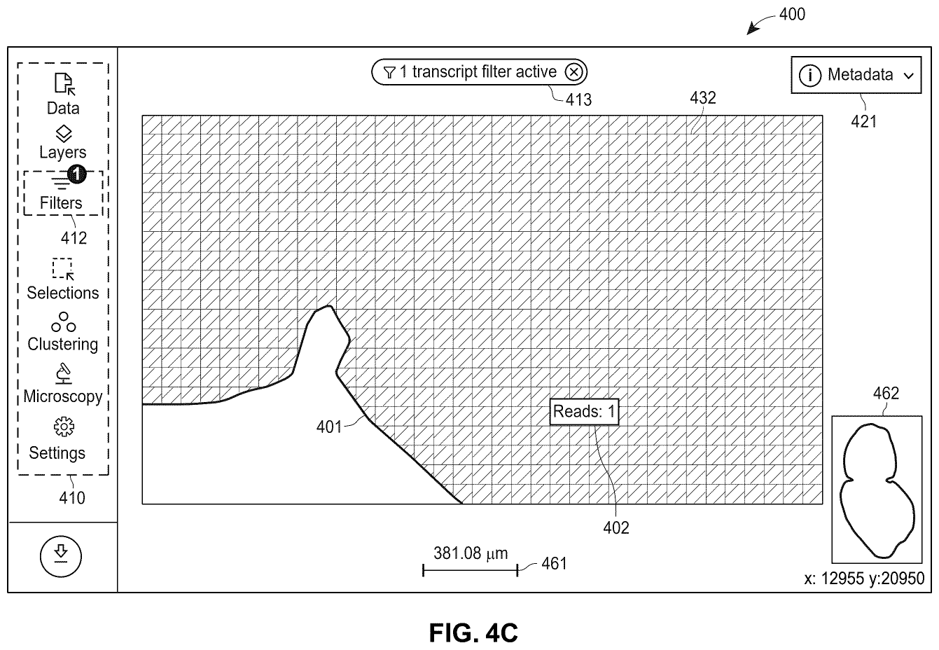

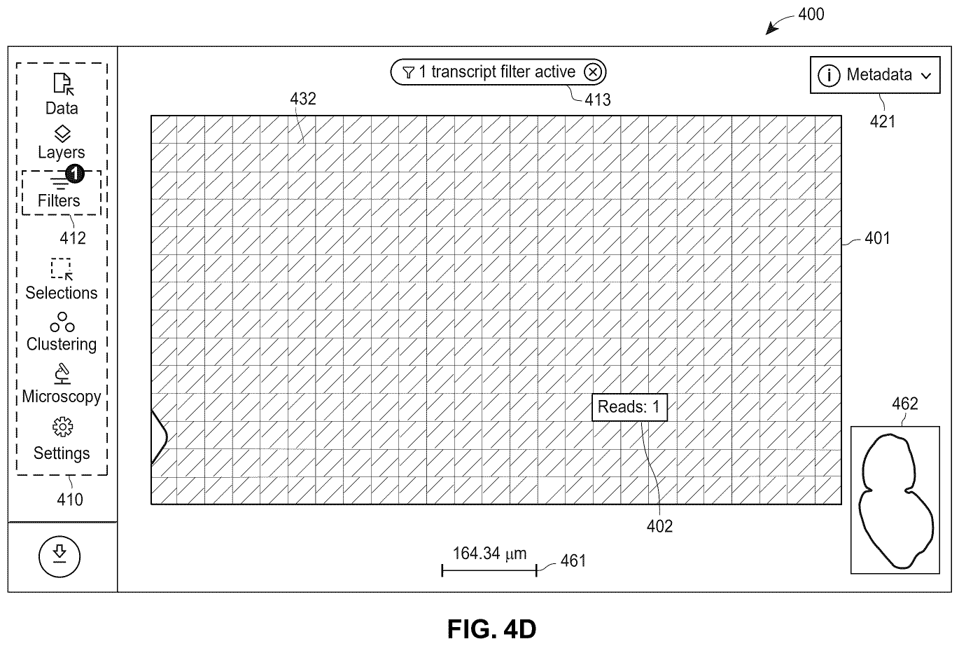

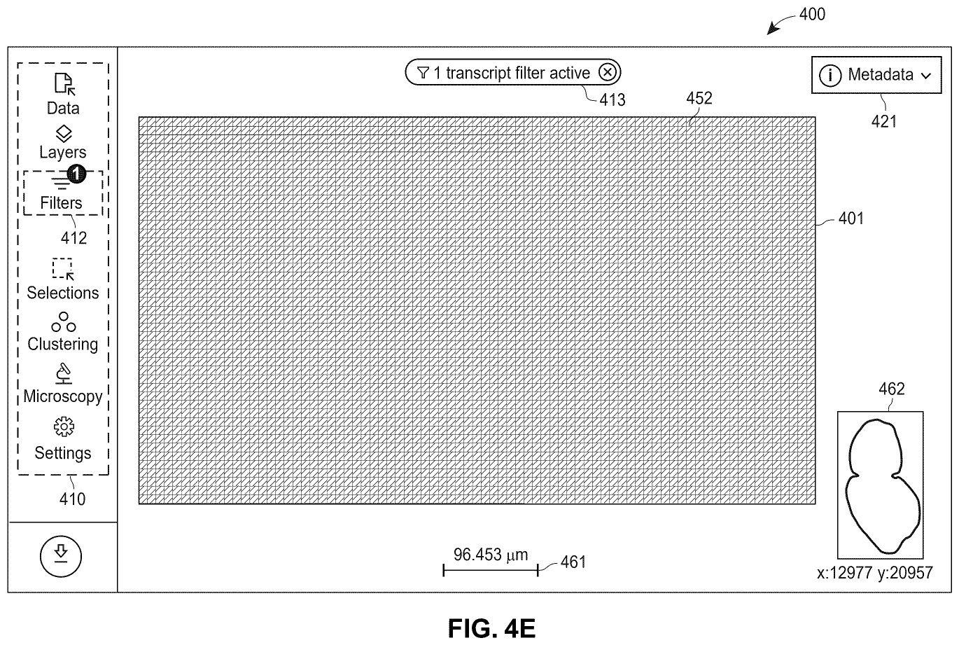

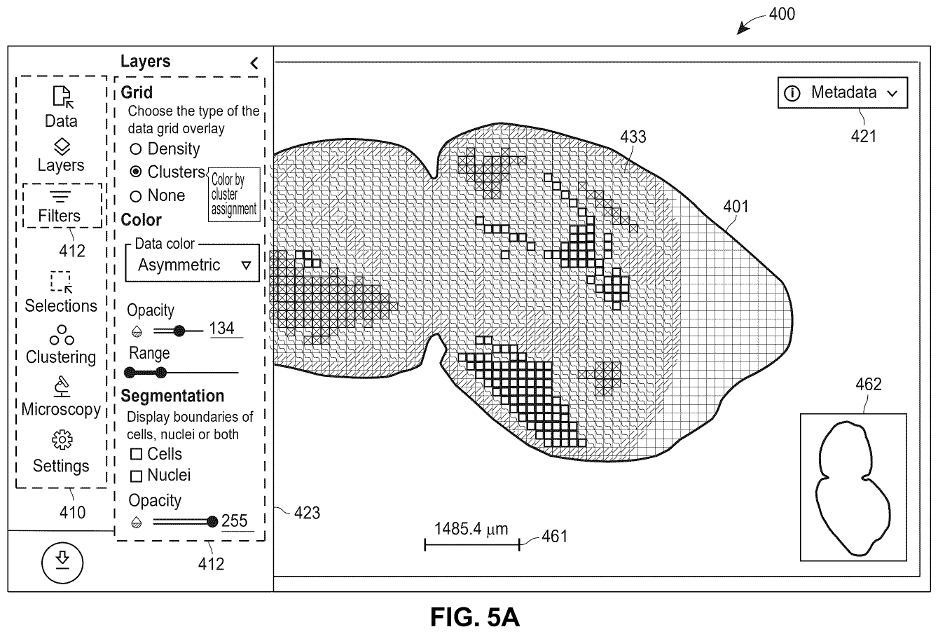

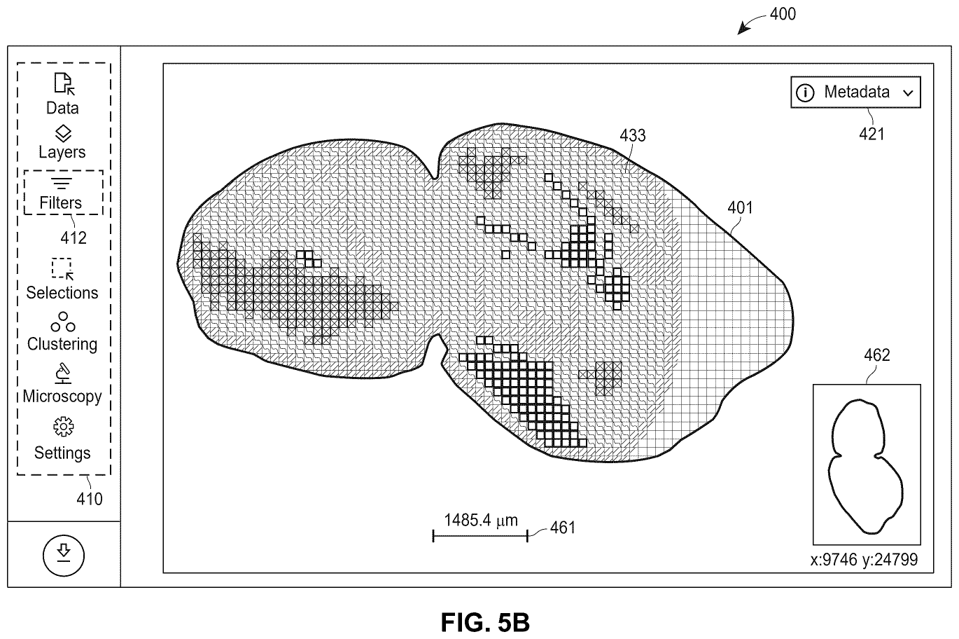

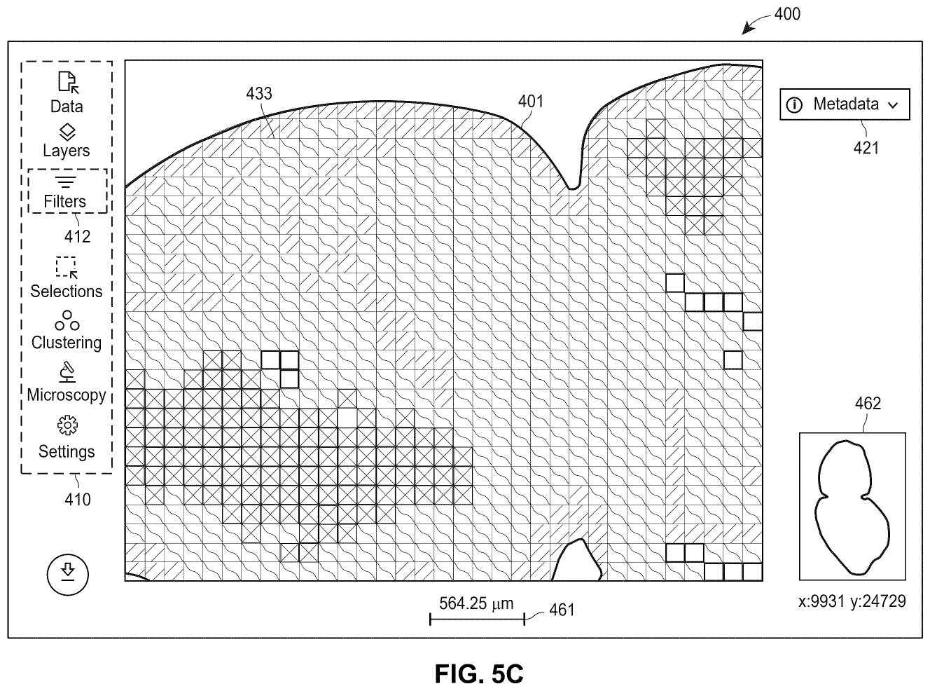

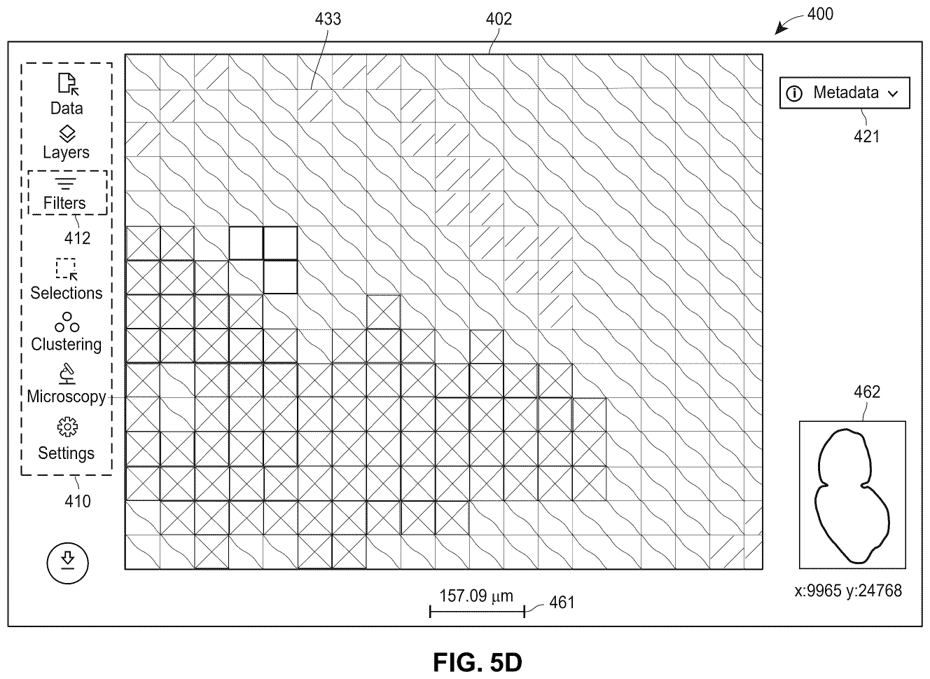

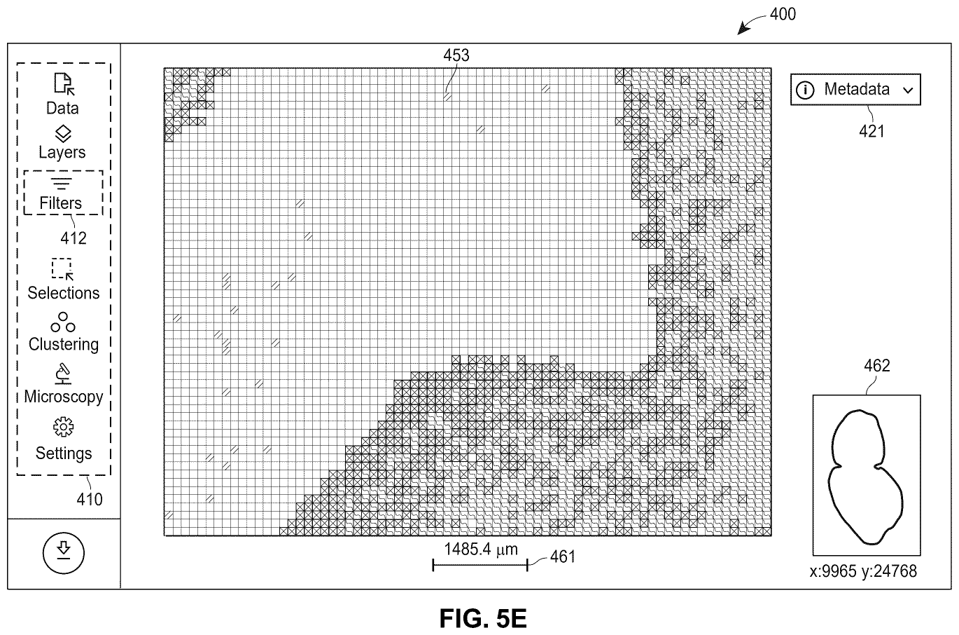

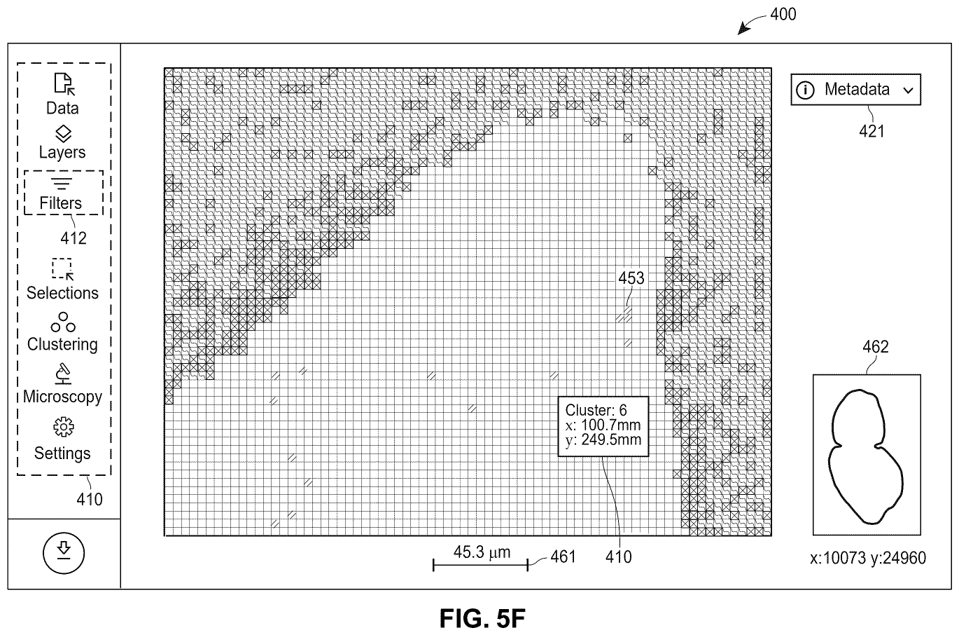

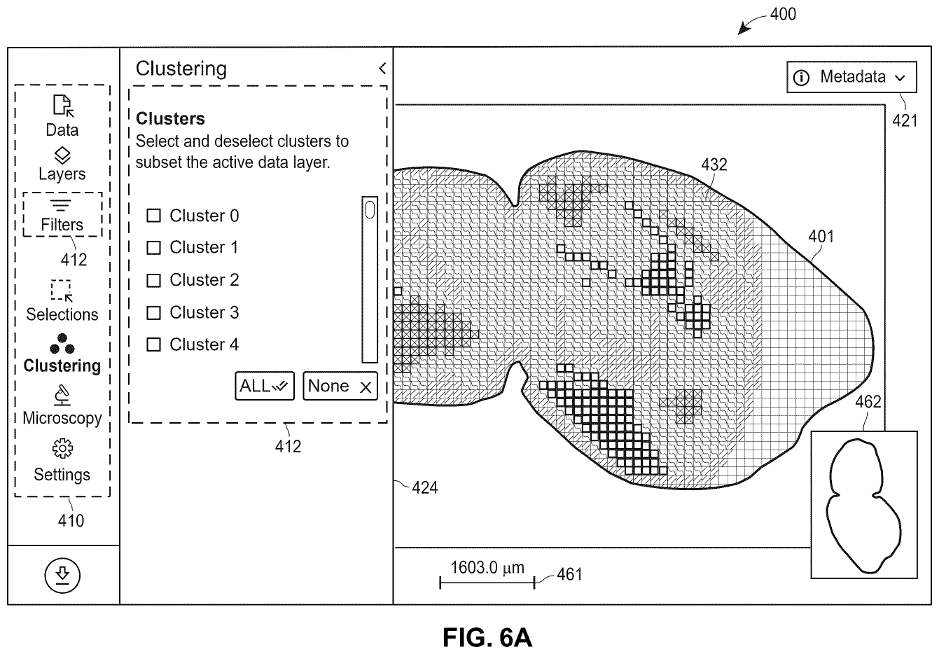

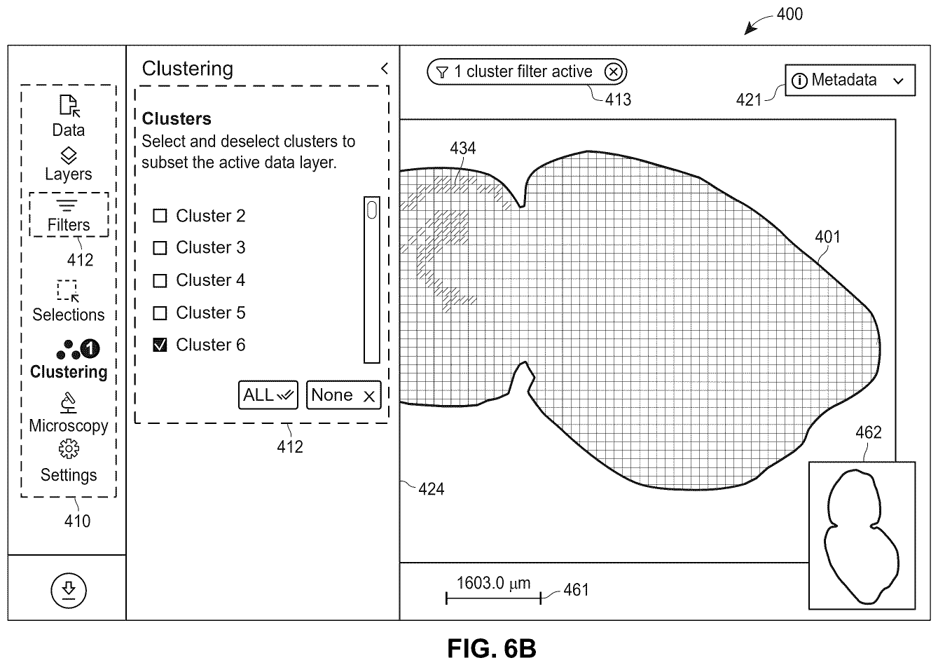

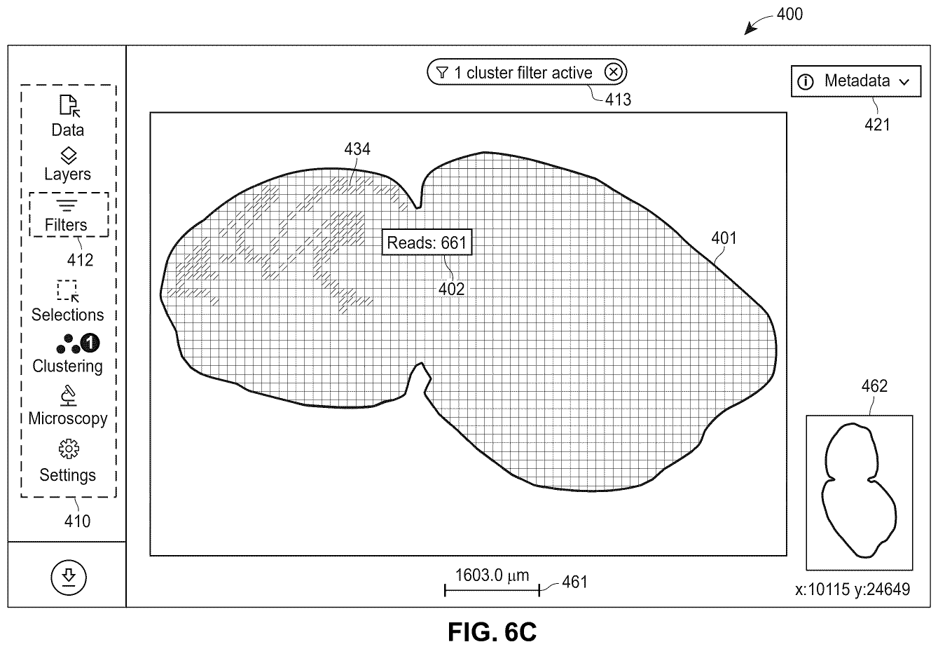

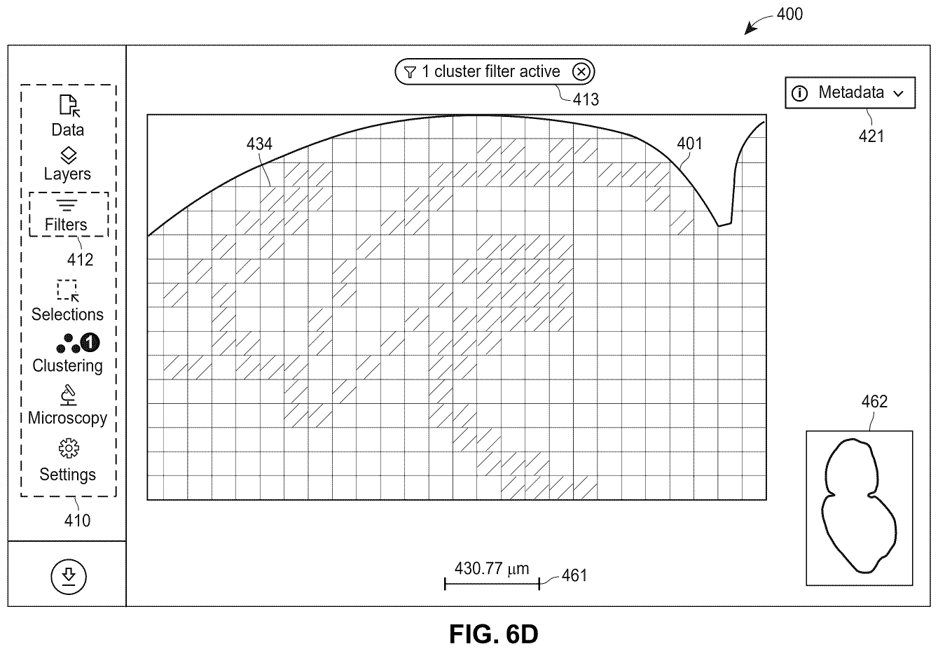

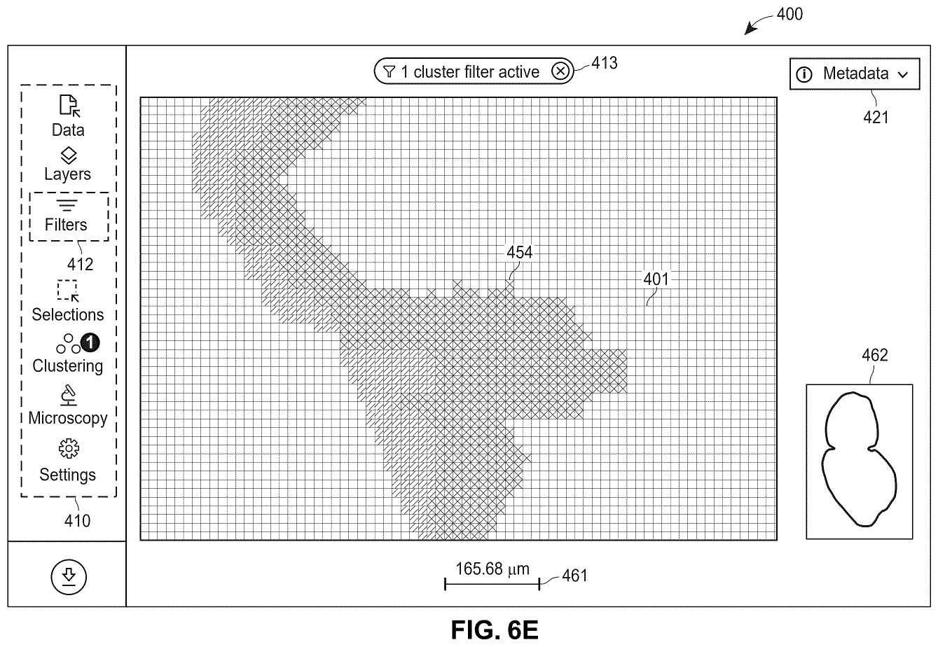

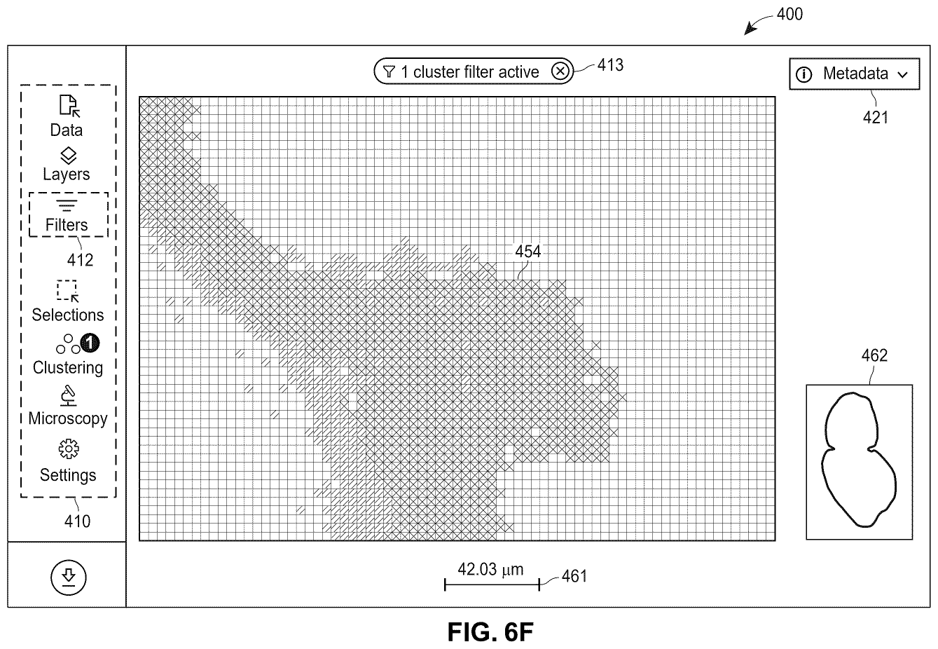

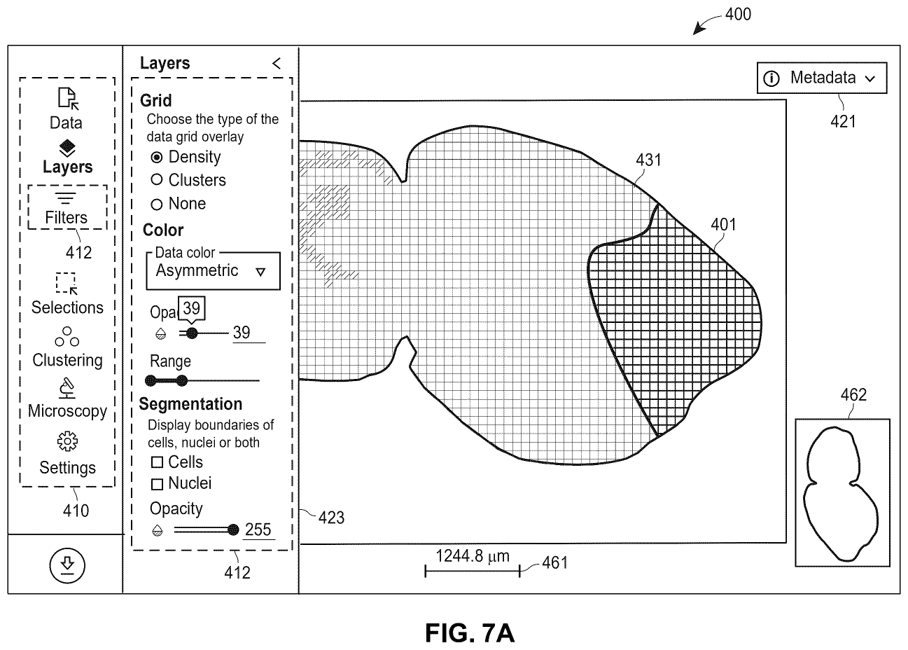

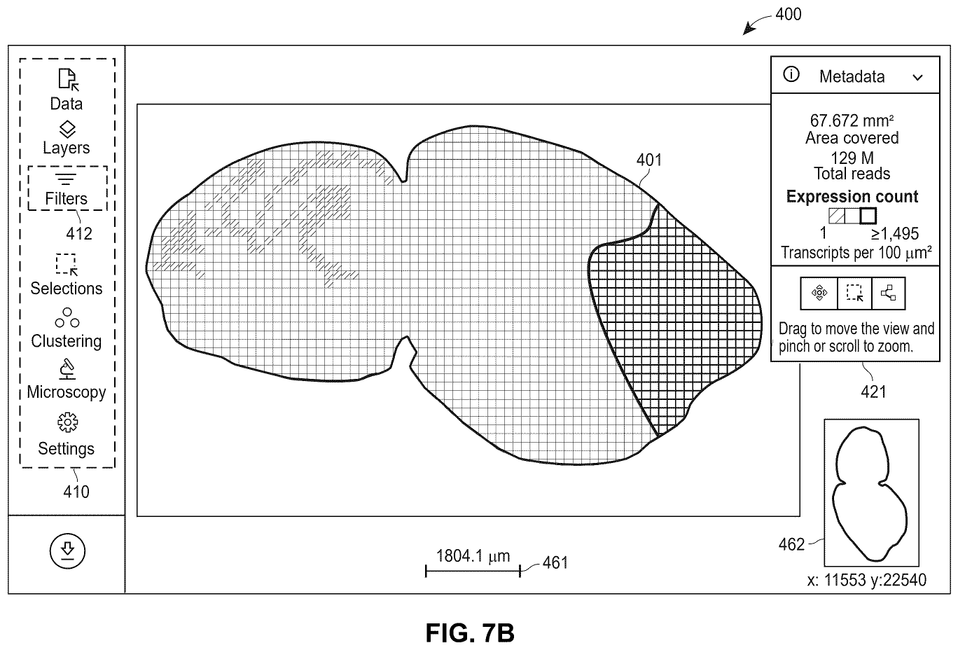

Particularly, FIGS. 3A-3H depict an example GUI for presenting a summary view and a detailed view of spatial transcriptomics data for a region of tissue with low resolution and high resolution bins, respectively. FIGS. 4A-4E depict an example GUI with a user control for filtering the summary view and the detailed view by gene. FIGS. 5A-5F depict an example GUI for segmenting bins within the summary view and the detailed view into clusters based on gene expression patterns within the region of tissue. FIGS. 6A-6E depict an example GUI with a user control for filtering the summary view and the detailed view by cluster. FIGS. 7A-7B depict an example GUI with a user control for selecting a transparency level for presenting the bins.

The spatial transcriptomics display application 44 may display the GUIs of FIGS. 3A-7B in accordance with one or more methods or processes, such as the method 300 illustrated in FIG. 2 described above. As illustrated, FIGS. 3A-7B depict an example GUI 400 with multiple windows, tabs, components, and functionalities, but any of the foregoing may be implemented via distinct GUIs and/or portions of a GUI.

As illustrated by FIGS. 3A-3H, the example GUI 400 may include an image of a region of tissue 401 divided into bins 431, 451 having a low resolution and a high resolution, respectively. The image is presented within a viewport 450. For each bin 431, 451, the GUI 400 presents an indication of the expression count 402 of the number of reads of genomic sequences within the bin 431, 451. The GUI 400 presents a heat map based on the expression count, such that bins 431, 451 with higher counts are represented with warmer colors (e.g., orange, red) and bins 431, 451 with lower counts are represented with cooler colors (e.g., yellow, blue).

Additionally, the GUI 400 presents an interactable GUI control panel 410, one or more interactable GUI elements 412, a metadata window 421, a zoom scale 461 indicating the presently displayed zoom level of the example GUI 400, and a full view map 462 depicting the full view of the region of tissue 401 presented in the viewport 450.

The image of the region of tissue 401 may be displayed in the background of the example GUI 400 such that the remaining components of the example GUI listed above may be overlaid on top of the image of the region of the tissue 401. In this manner, the spatial transcriptomics data (e.g., genomic sequence reads, clusters based on gene expression patterns, etc.) may be visually connected to the image data of a tissue sample.

The expression count 402 for a particular bin may be displayed via a mouse location listener. When the mouse hovers over a bin, the expression count within that bin will be displayed (as illustrated in FIGS. 3A, 3B, and 3E).

The interactable GUI control panel 410 may feature one or more interactable GUI elements 412 (e.g., the interactable buttons that feature icons and/or text such as the “Data” interactable button, the “Layers” interactable button, the “Filters” interactable button, the “Selections” interactable button, the “Clustering” interactable button, the “Microscopy” interactable button, and the “Settings” interactable button). When the user interacts with a GUI element 412, the GUI 400 may display and/or hide one or more windows (as illustrated in FIGS. 4A, 4C, 5A, 5B, 6A, 6C, 7A, and 7B).

The metadata window 421 of the example GUI 400 may provide information related to the spatial transcriptomics data. This may include the area of the region of the tissue, the total expression count for the region of tissue, a legend for the heat map indicating the colors that correspond to various expression count ranges, and GUI navigation options.

The low resolution bins 431 may be colored according to the legend for the heat map shown in FIG. 3A based on the expression counts for each bin 431. The high resolution second bins 451 may also be colored according to a legend for a heat map based on the expression counts for each bin 451.

As discussed above, the GUI 400 presents the low resolution bins 431 in a summary view for a first range of zoom levels at or below a threshold zoom level (e.g., as illustrated in FIGS. 3A-3D). The GUI 400 presents the high resolution bins 451 in a detailed view for a second range of zoom levels above the threshold zoom level (e.g., as illustrated in FIGS. 3E-3H). As shown in FIGS. 3A-3D, the user may zoom in and/or zoom out while remaining in the summary view of the example GUI 400 provided the user does not zoom in beyond the threshold zoom level. Similarly, as shown in FIGS. 3E-3H, the user may zoom in and/or zoom out while remaining in the detailed view of the example GUI 400 provided the user does not zoom out beyond the threshold zoom level. In some implementations, the example GUI 400 may initially display a default zoom level and/or a last recorded zoom level.

The zoom scale 461 indicates the scale of the presently displayed zoom level presented within the viewport 450. As the user zooms in, the scale 461 indicates that the viewport 450 represents smaller portions of the region of tissue 401. The full view map 462 depicts the full view of the region of tissue 401 as well as the current coordinates of the region of the tissue that are presented within the viewport (e.g., according to the centroid of the viewport, the last recorded placement of the user's mouse cursor, etc.).

When the user selects the “Filters” interactable button, the GUI 400 may present one or more conditional interactable GUI elements 413 and a gene filtering window 422 as shown in FIGS. 4A-4E. As illustrated in FIGS. 4A-4B, the gene filtering window 422 may be used to filter the expression counts for a particular gene or set of genes. In this manner, in addition to being able to view the total expression counts for each bin within a region of tissue, the user can view the number of reads within a bin that correspond to a particular gene.

For example, as illustrated in FIG. 4B, the user selects the gene Gpx1, and thus the GUI 400 presents the filtered expression counts for each bin 432 indicating the number of reads within the bin 432 that correspond to Gpx1. If a bin does not have any reads that correspond to Gpx1, the bin may not be presented within the GUI 400. Additionally or alternatively, once the user has filtered the expression counts for a particular gene or set of genes, the one or more conditional interactable GUI elements 413 (e.g., the pop-up interactable element with the text “1 transcript filter active”) may be displayed. The user may interact with the one or more conditional interactable GUI elements 413 (e.g., by clicking on the “X” icon on the pop-up interactable element) to cancel or modify the current filtering criteria.

As illustrated in FIGS. 4A-4E, the GUI 400 presents the filtered low resolution bins 432 in the summary view for a first range of zoom levels at or below a threshold zoom level (e.g., as illustrated in FIGS. 4B-4D). The GUI 400 presents the filtered high resolution bins 452 in the detailed view for a second range of zoom levels above the threshold zoom level (e.g., as illustrated in FIG. 4E). As shown in FIGS. 4B-4D, the user may zoom in and/or zoom out while remaining in summary view of the example GUI 400 provided the user does not zoom in beyond the threshold zoom level. Similarly, as shown in FIG. 4E, the user may zoom in and/or zoom out while remaining in detailed view of the example GUI 400 provided the user does not zoom out beyond the threshold zoom level.

In some implementations, in addition or as an alternative to viewing the expression counts of bins within the region of tissue, the user may view clusters assigned to each bin, for example according to gene expression patterns within the bins. FIGS. 5A-5F illustrate the bins grouped into clusters. As shown in FIGS. 5A-5F, in addition to the components illustrated in FIGS. 3A-4E, the example GUI 400 may also include a layers window 423 of the example GUI 400.

In some implementations, the layers window 223 may be displayed when the user selects the interactable button with the text “Layers” from the interactable GUI control panel 410. The layers window 223 may include user controls for the user to switch from viewing expression counts/densities to viewing clusters. For example, if the user selects the interactable selection element with the text “Density,” the GUI 400 may present the expression count for each bin, as shown in FIGS. 3A-3H. On the other hand, if the user selects the interactable selection element with the text “Cluster,” the spatial transcriptomics display application 44 generates a group of candidate clusters in which to assign both the low resolution and the high resolution bins 433, 453. For example, the spatial transcriptomics display application 44 may generate the group of candidate clusters based on the gene expression patterns within the high resolution bins 453. Then the spatial transcriptomics display application 44 assigns clusters from the group of candidate clusters to each of the high resolution bins 453 and each of the low resolution bins 433. For example, the spatial transcriptomics display application 44 may assign the clusters to the low resolution bins 433 using a majority vote system, or by generating polygons outlining contiguous portions of high resolution bins assigned the same cluster and presenting the polygons overlaying low resolution bins that correspond to the contiguous portion of high resolution bins, as described above.

Then each cluster may be represented as a different color, such that the bins are presented with colors corresponding to their assigned clusters. For example, bins assigned to a second cluster may be presented with the color green, while bins assigned to a sixth cluster may be presented with the color salmon.

As illustrated in FIGS. 5A-5F, the GUI 400 presents the clustered low resolution bins 433 in the summary view for a first range of zoom levels at or below a threshold zoom level (e.g., as illustrated in FIGS. 5A-5D). The GUI 400 presents the clustered high resolution bins 453 in the detailed view for a second range of zoom levels above the threshold zoom level (e.g., as illustrated in FIGS. 5E-5F). As shown in FIGS. 5A-5D, the user may zoom in and/or zoom out while remaining in summary view of the example GUI 400 provided the user does not zoom in beyond the threshold zoom level. Similarly, the user may zoom in and/or zoom out while remaining in detailed view of the example GUI 400 provided the user does not zoom out beyond the threshold zoom level.

As illustrated by FIGS. 6A-6E, in addition to the components as illustrated in FIGS. 3A-5F, the example GUI 400 may also include a cluster filtering window 424 of the example GUI 400. In some implementations, the cluster filtering window 424 may be displayed when the user selects the interactable button with the text “Clusters” from the interactable GUI control panel 410. As illustrated in FIGS. 6A-6B, the cluster filtering window 424 may be used to filter the low resolution bins 434 and the high resolution bins 454 by a particular cluster or set of clusters within the group of clusters. For example, as illustrated in FIG. 6B, the user has selected cluster 6.

Thus, the GUI 400 filters the viewport 450 to only include bins 434, 454 assigned cluster 6. It is important to note that because the GUI 400 is filtered by cluster, the bins 434, 454 are not color coded by cluster, and instead are color coded according to the heat map for expression count, similar to the bins 431, 451 in FIGS. 3A-3H. Additionally or alternatively, once the user has filtered the bins 434, 454 by cluster, the one or more conditional interactable GUI elements 413 (e.g., the pop-up interactable element with the text “1 cluster filter active”) may be displayed. The user may interact with the one or more conditional interactable GUI elements 413 (e.g., by clicking on the “X” icon on the pop-up interactable element) to cancel or modify the current filtering criteria.

As illustrated in FIGS. 6A-6E, the GUI 400 presents the cluster-filtered low resolution bins 434 in the summary view for a first range of zoom levels at or below a threshold zoom level (e.g., as illustrated in FIGS. 6B-6D). The GUI 400 presents the cluster-filtered high resolution bins 454 in the detailed view for a second range of zoom levels above the threshold zoom level (e.g., as illustrated in FIG. 6E). As shown in FIGS. 6B-6D, the user may zoom in and/or zoom out while remaining in summary view of the example GUI 400 provided the user does not zoom in beyond the threshold zoom level. Similarly, the user may zoom in and/or zoom out while remaining in the detailed view of the example GUI 400 provided the user does not zoom out beyond the threshold zoom level.

As illustrated by FIGS. 7A-7B, in addition to the components as illustrated in FIGS. 3A-6E, the example GUI 400 may also include an opacity/transparency selection function for overlaying the bins 431, 451 over the region of tissue 401. As shown in FIG. 7A, the opacity of may be adjusted such that the region of the tissue 401 is visible behind the bins 431, 451. Additionally or alternatively, as shown in FIG. 7B, the user may select an opacity level that is so low that the overlayed data is entirely transparent. In this manner, only the image of the region of tissue 401 is visible within the viewport.

Example 1. A method for presenting spatial transcriptomics data at a plurality of resolutions, the method comprising: presenting, by one or more processors in a viewport, a first display representing a region of tissue at a first zoom level, wherein the region of tissue is divided into first bins each having a first resolution, the first display indicating first feature values for the first bins within the region of tissue for a feature related to spatial transcriptomics, each of the first feature values selected from a set of candidate feature values; and in response to receiving a selection of a user control to zoom in on a portion of the region at a second zoom level, presenting, by the one or more processors in the viewport, a second display representing the portion of the region at the second zoom level, wherein the portion of the region is divided into second bins each having a second resolution which correspond to smaller areas within the region of tissue than the first bins, the second display indicating second feature values for the second bins within the portion of the region, wherein the second feature values are selected from the same set of candidate feature values, such that the first and second feature values are consistent across the first and second resolutions.

Example 2. The method of example 1, further comprising: identifying, by the one or more processors, the set of candidate feature values using spatial transcriptomics data within each of the second bins; assigning, by the one or more processors, the first feature values from the set of candidate feature values to the first bins; and assigning, by the one or more processors, the second feature values from the set of candidate feature values to the second bins.

Example 3. The method of example 1 or example 2, wherein assigning a first feature value to one of the first bins includes: identifying, by the one or more processors, a subset of the second bins which are located within an area corresponding to the first bin; identifying, by the one or more processors, second feature values for the subset of the second bins; and identifying, by the one or more processors, a second feature value which occurs most frequently in the subset as the first feature value.

Example 4. The method of any of the preceding examples, further comprising: dividing, by the one or more processors, the region of tissue into a plurality of tiles; for each tile, storing, by the one or more processors, the second feature values for a subset of the second bins which are located within an area corresponding to the tile in memory; and in response to receiving a selection of a user control to zoom in at a particular location: identifying, by the one or more processors, the tile which corresponds to the particular location; retrieving, by the one or more processors, the second feature values for the subset of the second bins which correspond to the tile from the memory; and presenting, by the one or more processors, the tile in the viewport, including the retrieved second feature values for the subset of second bins which correspond to the tile.

Example 5. The method of any of the preceding examples, wherein presenting the first display includes: generating, by the one or more processors, a polygon outlining a contiguous portion of the second bins each having a same second feature value, wherein the polygon includes an indicator representing the second feature value; and presenting, by the one or more processors, the polygon in the first display overlaying one or more first bins corresponding to the contiguous portion of the second bins, such that the polygon indicates one or more first feature values for the one or more first bins.

Example 6. The method of any of the preceding examples, wherein the first bins at the first resolution are displayed for a first range of zoom levels lower than a threshold zoom level, and the second bins at the second resolution are displayed for a second range of zoom levels higher than the threshold zoom level.

Example 7. The method of any of the preceding examples, wherein the second display is presented in the viewport in response to receiving a selection of a user control to view the portion of the region at a zoom level which is higher than the threshold zoom level.

Example 8. The method of any of the preceding examples, further comprising: in response to receiving a selection of a user control to view the portion of the region at a zoom level which is lower than the threshold zoom level, presenting, by the one or more processors, the portion of the region in the viewport with the first bins at the first resolution.

Example 9. The method of any of the preceding examples, further comprising: filtering, by the one or more processors, the viewport to present a subset of the candidate feature values.

Example 10. The method of any of the preceding examples, wherein the feature related to spatial transcriptomics is a group of clusters within the region of tissue according to at least gene expression, such that each of the candidate feature values corresponds to one of the group of clusters.

Example 11. A system for presenting spatial transcriptomics data at a plurality of resolutions, the system comprising: one or more processors; one or more memories coupled to the one or more processors; and computer-readable instructions stored in the one or more memories that, when executed by the one or more processors, cause the system to: present, in a viewport, a first display representing a region of tissue at a first zoom level, wherein the region of tissue is divided into first bins each having a first resolution, the first display indicating first feature values for the first bins within the region of tissue for a feature related to spatial transcriptomics, each of the first feature values selected from a set of candidate feature values, and in response to receiving a selection of a user control to zoom in on a portion of the region at a second zoom level, present, in the viewport, a second display representing the portion of the region at the second zoom level, wherein the portion of the region is divided into second bins each having a second resolution which correspond to smaller areas within the region of tissue than the first bins, the second display indicating second feature values for the second bins within the portion of the region, wherein the second feature values are selected from the same set of candidate feature values, such that the first and second feature values are consistent across the first and second resolutions.

Example 12. The system of example 11, wherein the instructions further cause the system to: identify the set of candidate feature values using spatial transcriptomics data within each of the second bins, assign the first feature values from the set of candidate feature values to the first bins, and assign the second feature values from the set of candidate feature values to the second bins.

Example 13. The system of example 11 or example 12, wherein to assign a first feature value to one of the first bins, the instructions cause the system to: identify a subset of the second bins which are located within an area corresponding to the first bin, identify second feature values for the subset of the second bins, and identify a second feature value which occurs most frequently in the subset as the first feature value.

Example 14. The system of any of examples 11 to 13, wherein the instructions further cause the system to: divide the region of tissue into a plurality of tiles, for each tile, store the second feature values for a subset of the second bins which are located within an area corresponding to the tile in memory, and in response to receiving a selection of a user control to zoom in at a particular location: identify the tile which corresponds to the particular location, retrieve the second feature values for the subset of the second bins which correspond to the tile from the memory, and present the tile in the viewport, including the retrieved second feature values for the subset of second bins which correspond to the tile.

Example 15. The system of any one of examples 11 to 14, wherein to present the first display, the instructions cause the system to: generate a polygon outlining a contiguous portion of the second bins each having a same second feature value, wherein the polygon includes an indicator representing the second feature value, and present the polygon in the first display overlaying one or more first bins corresponding to the contiguous portion of the second bins, such that the polygon indicates one or more first feature values for the one or more first bins.

Example 16. The system of any one of examples 11 to 15, wherein the first bins at the first resolution are displayed for a first range of zoom levels lower than a threshold zoom level, and the second bins at the second resolution are displayed for a second range of zoom levels higher than the threshold zoom level.

Example 17. The system of any one of examples 11 to 16, wherein the second display is presented in the viewport in response to receiving a selection of a user control to view the portion of the region at a zoom level which is higher than the threshold zoom level.

Example 18. The system of any one of examples 11 to 17, wherein the instructions further cause the system to: in response to receiving a selection of a user control to view the portion of the region at a zoom level which is lower than the threshold zoom level, present the portion of the region in the viewport with the first bins at the first resolution.

Example 19. The system of any one of examples 11 to 18, wherein the instructions further cause the system to: filter the viewport to present a subset of the candidate feature values.

Example 20. The system of any one of examples 11 to 19, wherein the feature related to spatial transcriptomics is a group of clusters within the region of tissue according to at least gene expression, such that each of the candidate feature values corresponds to one of the group of clusters.

### Additional Considerations

Although the disclosure herein sets forth a detailed description of numerous different implementations, it should be understood that the legal scope of the description is defined by the words of the claims set forth at the end of this patent and equivalents. The detailed description is to be construed as exemplary only and does not describe every possible implementation since describing every possible implementation would be impractical. Numerous alternative implementations may be implemented, using either current technology or technology developed after the filing date of this patent, which would still fall within the scope of the claims.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain implementations are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example implementations, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example implementations, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example implementations, the processor or processors may be located in a single location, while in other implementations the processors may be distributed across a number of locations.

The performance of certain of the operations may be distributed among the one or more processors, not only residing within a single machine, but deployed across a number of machines. In some example implementations, the one or more processors or processor-implemented modules may be located in a single geographic location (e.g., within a home environment, an office environment, or a server farm). In other implementations, the one or more processors or processor-implemented modules may be distributed across a number of geographic locations.

This detailed description is to be construed as exemplary only and does not describe every possible implementation, as describing every possible implementation would be impractical, if not impossible. A person of ordinary skill in the art may implement numerous alternate implementations, using either current technology or technology developed after the filing date of this application.

Those of ordinary skill in the art will recognize that a wide variety of modifications, alterations, and combinations may be made with respect to the above described implementations without departing from the scope of the invention, and that such modifications, alterations, and combinations are to be viewed as being within the ambit of the inventive concept.

The patent claims at the end of this patent application are not intended to be construed under 35 U.S.C. § 112 (f) unless traditional means-plus-function language is expressly recited, such as “means for” or “step for” language being explicitly recited in the claim(s). The systems and methods described herein are directed to an improvement to computer functionality and improve the functioning of conventional computers.

What is claimed is:

1. A method for presenting spatial transcriptomics data at a plurality of resolutions, the method comprising:
presenting, by one or more processors in a viewport, a first display representing a region of tissue at a first zoom level, wherein the region of tissue is divided into first bins each having a first resolution, the first display indicating first feature values for the first bins within the region of tissue for a feature related to spatial transcriptomics, each of the first feature values selected from a set of candidate feature values; and
in response to receiving a selection of a user control to zoom in on a portion of the region at a second zoom level, presenting, by the one or more processors in the viewport, a second display representing the portion of the region at the second zoom level, wherein the portion of the region is divided into second bins each having a second resolution which correspond to smaller areas within the region of tissue than the first bins, the second display indicating second feature values for the second bins within the portion of the region, wherein the second feature values are selected from the same set of candidate feature values, such that the first and second feature values are consistent across the first and second resolutions.

2. The method of claim 1, further comprising:
identifying, by the one or more processors, the set of candidate feature values using spatial transcriptomics data within each of the second bins;
assigning, by the one or more processors, the first feature values from the set of candidate feature values to the first bins; and
assigning, by the one or more processors, the second feature values from the set of candidate feature values to the second bins.

3. The method of claim 2, wherein assigning a first feature value to one of the first bins includes:
identifying, by the one or more processors, a subset of the second bins which are located within an area corresponding to the first bin;
identifying, by the one or more processors, second feature values for the subset of the second bins; and
identifying, by the one or more processors, a second feature value which occurs most frequently in the subset as the first feature value.

4. The method of claim 2, further comprising:
dividing, by the one or more processors, the region of tissue into a plurality of tiles;
for each tile, storing, by the one or more processors, the second feature values for a subset of the second bins which are located within an area corresponding to the tile in memory; and
in response to receiving a selection of a user control to zoom in at a particular location;
identifying, by the one or more processors, the tile which corresponds to the particular location;
retrieving, by the one or more processors, the second feature values for the subset of the second bins which correspond to the tile from the memory; and
presenting, by the one or more processors, the tile in the viewport, including the retrieved second feature values for the subset of second bins which correspond to the tile.

5. The method of claim 1, wherein presenting the first display includes:
generating, by the one or more processors, a polygon outlining a contiguous portion of the second bins each having a same second feature value, wherein the polygon includes an indicator representing the second feature value; and
presenting, by the one or more processors, the polygon in the first display overlaying one or more first bins corresponding to the contiguous portion of the second bins, such that the polygon indicates one or more first feature values for the one or more first bins.

6. The method of claim 1, wherein the first bins at the first resolution are displayed for a first range of zoom levels lower than a threshold zoom level, and the second bins at the second resolution are displayed for a second range of zoom levels higher than the threshold zoom level.

7. The method of claim 6, wherein the second display is presented in the viewport in response to receiving a selection of a user control to view the portion of the region at a zoom level which is higher than the threshold zoom level.

8. The method of claim 6, further comprising:
in response to receiving a selection of a user control to view the portion of the region at a zoom level which is lower than the threshold zoom level, presenting, by the one or more processors, the portion of the region in the viewport with the first bins at the first resolution.

9. The method of claim 1, further comprising:
filtering, by the one or more processors, the viewport to present a subset of the candidate feature values.

10. The method of claim 1, wherein the feature related to spatial transcriptomics is a group of clusters within the region of tissue according to at least gene expression, such that each of the candidate feature values corresponds to one of the group of clusters.

11. A system for presenting spatial transcriptomics data at a plurality of resolutions, the system comprising:
one or more processors;
one or more memories coupled to the one or more processors; and
computer-readable instructions stored in the one or more memories that, when executed by the one or more processors, cause the system to:
present, in a viewport, a first display representing a region of tissue at a first zoom level, wherein the region of tissue is divided into first bins each having a first resolution, the first display indicating first feature values for the first bins within the region of tissue for a feature related to spatial transcriptomics, each of the first feature values selected from a set of candidate feature values, and
in response to receiving a selection of a user control to zoom in on a portion of the region at a second zoom level, present, in the viewport, a second display representing the portion of the region at the second zoom level, wherein the portion of the region is divided into second bins each having a second resolution which correspond to smaller areas within the region of tissue than the first bins, the second display indicating second feature values for the second bins within the portion of the region, wherein the second feature values are selected from the same set of candidate feature values, such that the first and second feature values are consistent across the first and second resolutions.

12. The system of claim 11, wherein the instructions further cause the system to:
identify the set of candidate feature values using spatial transcriptomics data within each of the second bins,
assign the first feature values from the set of candidate feature values to the first bins, and
assign the second feature values from the set of candidate feature values to the second bins.

13. The system of claim 12, wherein to assign a first feature value to one of the first bins, the instructions cause the system to:
identify a subset of the second bins which are located within an area corresponding to the first bin,
identify second feature values for the subset of the second bins, and
identify a second feature value which occurs most frequently in the subset as the first feature value.

14. The system of claim 12, wherein the instructions further cause the system to:
divide the region of tissue into a plurality of tiles,
for each tile, store the second feature values for a subset of the second bins which are located within an area corresponding to the tile in memory, and
in response to receiving a selection of a user control to zoom in at a particular location:
identify the tile which corresponds to the particular location,
retrieve the second feature values for the subset of the second bins which correspond to the tile from the memory, and
present the tile in the viewport, including the retrieved second feature values for the subset of second bins which correspond to the tile.

15. The system of claim 11, wherein to present the first display, the instructions cause the system to:
generate a polygon outlining a contiguous portion of the second bins each having a same second feature value, wherein the polygon includes an indicator representing the second feature value, and
present the polygon in the first display overlaying one or more first bins corresponding to the contiguous portion of the second bins, such that the polygon indicates one or more first feature values for the one or more first bins.

16. The system of claim 11, wherein the first bins at the first resolution are displayed for a first range of zoom levels lower than a threshold zoom level, and the second bins at the second resolution are displayed for a second range of zoom levels higher than the threshold zoom level.

17. The system of claim 16, wherein the second display is presented in the viewport in response to receiving a selection of a user control to view the portion of the region at a zoom level which is higher than the threshold zoom level.

18. The system of claim 16, wherein the instructions further cause the system to:
in response to receiving a selection of a user control to view the portion of the region at a zoom level which is lower than the threshold zoom level, present the portion of the region in the viewport with the first bins at the first resolution.

19. The system of claim 11, wherein the instructions further cause the system to:
filter the viewport to present a subset of the candidate feature values.

20. The system of claim 11, wherein the feature related to spatial transcriptomics is a group of clusters within the region of tissue according to at least gene expression, such that each of the candidate feature values corresponds to one of the group of clusters.
